(19) United States
(12) Patent Application Publication
(10) Pub. No.: US 2025/0392059 A1
(43) Pub. Date: Dec. 25, 2025

(54) BUSBAR CONNECTION BODY AND STRUCTURE

(71) Applicant: Japan Aviation Electronics Industry, Limited, Tokyo (JP)

(72) Inventor: Akira KIMURA, Tokyo (JP)

(73) Assignee: Japan Aviation Electronics Industry, Limited, Tokyo (JP)

(21) Appl. No.: 19/202,124

(22) Filed: May 8, 2025

(30) Foreign Application Priority Data
Jun. 21, 2024 (JP) 2024-100364

(51) Int. Cl. H01R 4/30; H01R 13/621

(52) U.S. Cl. CPC H01R 4/305; H01R 13/621

(57) ABSTRACT

A busbar connection body comprises a first busbar, a second busbar, a press mechanism and a regulating member. The first busbar has a first contact portion. The second busbar has a second contact portion. The press mechanism comprises a bolt, a first member and a second member. The first member has a pressing portion and a converting surface. The second member has a force application portion. The regulating member has a receiving portion. The force application portion presses the converting surface at least in a first direction when the bolt is fastened under a state where the second contact portion is positioned between the first contact portion and the receiving portion in an accommodation space. When the force application portion presses the converting surface, the pressing portion presses the first contact portion against the second contact portion in a second direction while the receiving portion receives the second contact portion.

### CROSS REFERENCE TO RELATED APPLICATIONS

This application is based on and claims priority under 35 U.S.C. § 119 to Japanese Patent Applications No. JP 2024-100364 filed Jun. 21, 2024, the contents of which are incorporated herein in their entirety by reference.

### BACKGROUND OF THE INVENTION

This invention relates to a busbar connection body comprising a first busbar and a second busbar.

JPA 2011-159544 (Patent Document 1) discloses a feed structure 900, or a busbar connection body 900, of this type. Referring to FIG. 52, the busbar connection body 900 comprises a feed busbar 910, or a first busbar 910, a feed busbar 920, or a second busbar 920, a screw 930, or a bolt 930, and a metal shield 940. The first busbar 910 has a contact surface 912, or a first contact portion 912, and an attachment hole 914. The first contact portion 912 extends in an X-direction. The attachment hole 914 is a hole piercing the first contact portion 912 in a Z-direction. The second busbar 920 has a contact surface 922, or a second contact portion 922, and an attachment hole 924. The second contact portion 922 extends in the X-direction. The attachment hole 924 is a hole piercing the second contact portion 922 in the Z-direction. The bolt 930 has a shaft portion 932 extending in the Z-direction. The metal shield 940 has an attachment hole 942 piercing the metal shield 940 in the Z-direction. When the shaft portion 932 of the bolt 930 passes through the attachment holes 914, 924, 942 so that first busbar 910 and the second busbar 920 are fastened to each other by the bolt 930, the first contact portion 912 and the second contact portion 922 are connected to each other via the metal shield 940 in the Z-direction, or in the direction in which the shaft portion 932 extends.

In the busbar connection body 900 of Patent Document 1, the bolt 930 is screwed to each of the first connection portion 912 and the second contact portion 922 in a direction, which is perpendicular to each of the first contact portion 912 and the second contact portion 922, when the first busbar 910 and the second busbar 920 are fastened to each other by the bolt 930. Accordingly, in a busbar connection body such as the busbar connection body 900 of Patent Document 1, extra space for operation of fastening a bolt is required beyond the busbar connection body in a direction perpendicular to each of a first contact portion and a second contact portion. This extra space unnecessarily restricts placement of components around the busbar connection body. If a busbar connection body is modified so that space for operation of fastening a bolt is provided along a direction in which each of a first contact portion and a second contact portion extends, extra space for operation of fastening the bolt is not required beyond the modified busbar connection body in a direction perpendicular to each of the first contact portion and the second contact portion. Accordingly, the above problem does not arise in the modified busbar connection body. Thus, there is a need for a busbar connection body whose space for operation of fastening a bolt is provided along a direction in which each of a first contact portion and a second contact portion extends.

### SUMMARY OF THE INVENTION

It is therefore an object of the present invention to provide a busbar connection body whose space for operation of fastening a first busbar and a second busbar to each other by a bolt is provided along a direction in which each of a first contact portion and a second contact portion extends.

One aspect (first aspect) of the present invention provides a busbar connection body comprising a first busbar, a second busbar, a press mechanism and a regulating member. The first busbar has a first contact portion. The second busbar has a second contact portion. The press mechanism comprises a bolt, a first member and a second member. The bolt has a shaft portion extending in a first direction. The first member has a pressing portion and a converting surface. The converting surface intersects with both the first direction and a second direction perpendicular to the first direction. The second member has a force application portion. The regulating member has a receiving portion. The receiving portion is positioned apart from the pressing portion in the second direction. The busbar connection body has a predetermined distance between the pressing portion and the receiving portion in the second direction before the bolt is fastened. The predetermined distance is greater than a sum of a thickness of the first contact portion and a thickness of the second contact portion. The busbar connection body is formed with an accommodation space which accommodates both the first contact portion and the second contact portion. The accommodation space is positioned between the pressing portion and the receiving portion. The force application portion presses the converting surface at least in the first direction when the bolt is fastened under a state where the second contact portion is positioned between the first contact portion and the receiving portion in the accommodation space. When the force application portion presses the converting surface, the pressing portion presses the first contact portion against the second contact portion in the second direction while the receiving portion receives the second contact portion.

Another aspect (second aspect) of the present invention provides a structure comprising a first housing, a first busbar, a press mechanism and a regulating member. The first busbar has a first contact portion. The press mechanism comprises a bolt, a first member and a second member. The bolt has a shaft portion extending in a first direction. The first member has a pressing portion and a converting surface. The converting surface intersects with both the first direction and a second direction perpendicular to the first direction. The second member has a force application portion. The regulating member has a receiving portion. The receiving portion is positioned apart from the pressing portion in the second direction. The bolt also serves as the second member. The bolt is formed with a conical base portion. The conical base portion functions as the force application portion. The regulating member further has a main portion and an arm portion. The main portion is formed with a facing taper portion. The arm portion extends from the main portion and supports the receiving portion. When the bolt is fastened, the conical base portion presses the converting surface so that the pressing portion is moved toward the receiving portion. When the bolt is fastened, the conical base portion presses the facing taper portion so that the receiving portion is moved toward the pressing portion. The first housing holds the first busbar, the press mechanism and the regulating member. Each of the regulating member and the first member is movable in the second direction.

Still another aspect (third aspect) of the present invention provides a structure comprising a first housing, a first busbar, a press mechanism and a regulating member. The first busbar has a first contact portion. The press mechanism comprises a bolt, a first member and a second member. The bolt has a shaft portion extending in a first direction. The first member has a pressing portion and a converting surface. The converting surface intersects with both the first direction and a second direction perpendicular to the first direction. The second member has a force application portion. The regulating member has a receiving portion. The receiving portion is positioned apart from the pressing portion in the second direction. The second member further has a piercing hole and an extending portion. The bolt is inserted into the piercing hole. The extending portion extends along the first direction. The force application portion is provided on the extending portion. The regulating member further has a main portion and an arm portion. The arm portion extends from the main portion and supports the receiving portion. Each of the extending portion and the first member is positioned between the receiving portion and the main portion. When the bolt is fastened, the second member is moved along the first direction while the force application portion presses the converting surface. The extending portion is formed with an additional force application portion. The main portion is formed with a facing taper portion. When the bolt is fastened, the additional force application portion presses the facing taper portion so that the receiving portion is moved toward the pressing portion. The first housing holds the first busbar, the press mechanism and the regulating member. Each of the regulating member and the first member is movable in the second direction.

The busbar connection body of the present invention is configured as follows: the busbar connection body comprises the first busbar, the second busbar, the press mechanism and the regulating member; the press mechanism comprises the bolt, the first member and the second member; the bolt has the shaft portion extending in the first direction; the force application portion of the second member presses the converting surface of the first member at least in the first direction when the bolt is fastened under the state where the second contact portion of the second busbar is positioned between the first contact portion of the first busbar and the receiving portion of the regulating member in the accommodation space; and when the force application portion presses the converting surface, the pressing portion of the first member presses the first contact portion against the second contact portion in the second direction, which is perpendicular to the first direction, while the receiving portion receives the second contact portion. Accordingly, the busbar connection body of the present invention is configured so that the direction, in which the shaft portion of the bolt for fastening the first busbar and the second busbar to each other extends, is perpendicular to the direction in which the first contact portion is pressed against the second contact portion. In other words, the busbar connection body of the present invention is configured so that the direction, in which the shaft portion of the bolt extends, coincides with a direction in which each of the first contact portion and the second contact portion extends. Thus, the busbar connection body of the present invention is configured so that space for operation of fastening the first busbar and the second busbar to each other by the bolt is provided along the direction in which each of the first contact portion and the second contact portion extends. Consequently, the busbar connection body of the present invention does not unnecessarily restrict placement of components around the busbar connection body.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is a perspective view showing a busbar connection body according to a first embodiment of the present invention. In the figure, a bolt is not fastened to a nut while a first busbar and a second busbar are not connected to each other.

FIG. 2 is a side view showing the busbar connection body of FIG. 1. In the figure, a part of the second busbar, a part of a second member and a part of a regulating member are illustrated by broken line.

FIG. 3 is another side view showing the busbar connection body of FIG. 2. In the figure, the bolt is fastened to the nut while the first busbar and the second busbar are connected to each other. Additionally, in the figure, a part of the first busbar, a part of the second busbar, a part of a first member, a part of the second member and a part of the regulating member are illustrated by broken line.

FIG. 4 is a perspective view showing a busbar connection body according to a second embodiment of the present invention. In the figure, a bolt is not fastened to a nut while none of first busbars are connected to any of second busbars.

FIG. 5 is a partially cutaway cross-sectional, perspective view showing the busbar connection body of FIG. 4.

FIG. 6 is another perspective view showing the busbar connection body of FIG. 4. In the figure, the bolt is fastened to the nut while each of the first busbars and a corresponding one of the second busbars are connected to each other.

FIG. 7 is a top view showing the busbar connection body of FIG. 6.

FIG. 8 is a cross-sectional view showing the busbar connection body of FIG. 7, taken along line A-A.

FIG. 9 is a cross-sectional view showing the busbar connection body of FIG. 7, taken along line B-B.

FIG. 10 is a perspective view showing a first structure which is included in the busbar connection body of FIG. 4.

FIG. 11 is a perspective view showing a second structure which is included in the busbar connection body of FIG. 4.

FIG. 12 is a perspective view showing a part of the busbar connection body of FIG. 4 which excludes a first housing, a second housing, one of connection components, one of the first busbars and one of the second busbars.

FIG. 13 is a perspective view showing a part of the busbar connection body of FIG. 6 which excludes the first housing, the second housing, the one of the connection components, the one of the first busbars and the one of the second busbars.

FIG. 14 is a cross-sectional view showing the busbar connection body of FIG. 13.

FIG. 15 is a perspective view showing a part of the busbar connection body of FIG. 12 which excludes the first busbar and the second busbar.

FIG. 16 is a cross-sectional view showing the busbar connection body of FIG. 15.

FIG. 17 is another cross-sectional view showing the busbar connection body of FIG. 15.

FIG. 18 is an exploded, perspective view showing the connection component which is included in the busbar connection body of FIG. 15.

FIG. 19 is a front view showing a first member which is included in the connection component of FIG. 18.

FIG. 20 is a rear view showing the first member of FIG. 19.

FIG. 21 is a top view showing the first member of FIG. 19.

FIG. 22 is a bottom view showing the first member of FIG. 19.

FIG. 23 is a side view showing the first member of FIG. 19.

FIG. 24 is a front view showing a regulating member which is included in the connection component of FIG. 18.

FIG. 25 is a rear view showing the regulating member of FIG. 24.

FIG. 26 is a top view showing the regulating member of FIG. 24.

FIG. 27 is a bottom view showing the regulating member of FIG. 24.

FIG. 28 is a side view showing the regulating member of FIG. 24.

FIG. 29 is a perspective view showing a busbar connection body according to a third embodiment of the present invention. In the figure, a bolt is not fastened to a nut while none of first busbars are connected to any of second busbars.

FIG. 30 is a cross-sectional view showing the busbar connection body of FIG. 29. In the figure, a part of a first structure is enlarged and illustrated.

FIG. 31 is another perspective view showing the busbar connection body of FIG. 29. In the figure, the bolt is fastened to the nut while each of the first busbars and a corresponding one of the second busbars are connected to each other.

FIG. 32 is a top view showing the busbar connection body of FIG. 31.

FIG. 33 is a cross-sectional view showing the busbar connection body of FIG. 32, taken along line C-C. In the figure, a part of the busbar connection body is enlarged and illustrated.

FIG. 34 is a cross-sectional view showing the busbar connection body of FIG. 32, taken along line D-D. In the figure, a part of the busbar connection body is enlarged and illustrated.

FIG. 35 is a perspective view showing a part of the busbar connection body of FIG. 29 which excludes a first housing and a second housing.

FIG. 36 is a perspective view showing a part of the busbar connection body of FIG. 31 which excludes the first housing and the second housing.

FIG. 37 is a perspective view showing the first structure which is included in the busbar connection body of FIG. 29.

FIG. 38 is a cross-sectional view showing the first structure of FIG. 37.

FIG. 39 is a perspective view showing a second structure which is included in the busbar connection body of FIG. 29.

FIG. 40 is a perspective view showing a connection component and a push-up member which are included in the busbar connection body of FIG. 35.

FIG. 41 is an exploded, perspective view showing the connection component of FIG. 40. In the figure, one of first members and one of regulating members are omitted.

FIG. 42 is a front view showing the first member which is included in the connection component of FIG. 41.

FIG. 43 is a rear view showing the first member of FIG. 42.

FIG. 44 is a top view showing the first member of FIG. 42.

FIG. 45 is a front view showing a second member coupling body which is included in the connection component of FIG. 41.

FIG. 46 is a top view showing the second member coupling body of FIG. 45.

FIG. 47 is a bottom view showing the second member coupling body of FIG. 45.

FIG. 48 is a side view showing the second member coupling body of FIG. 45.

FIG. 49 is a front view showing the regulating member which is included in the connection component of FIG. 41.

FIG. 50 is a rear view showing the regulating member of FIG. 49.

FIG. 51 is a top view showing the regulating member of FIG. 49.

FIG. 52 is an exploded, perspective view showing a feed structure of Patent Document 1.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

### First Embodiment

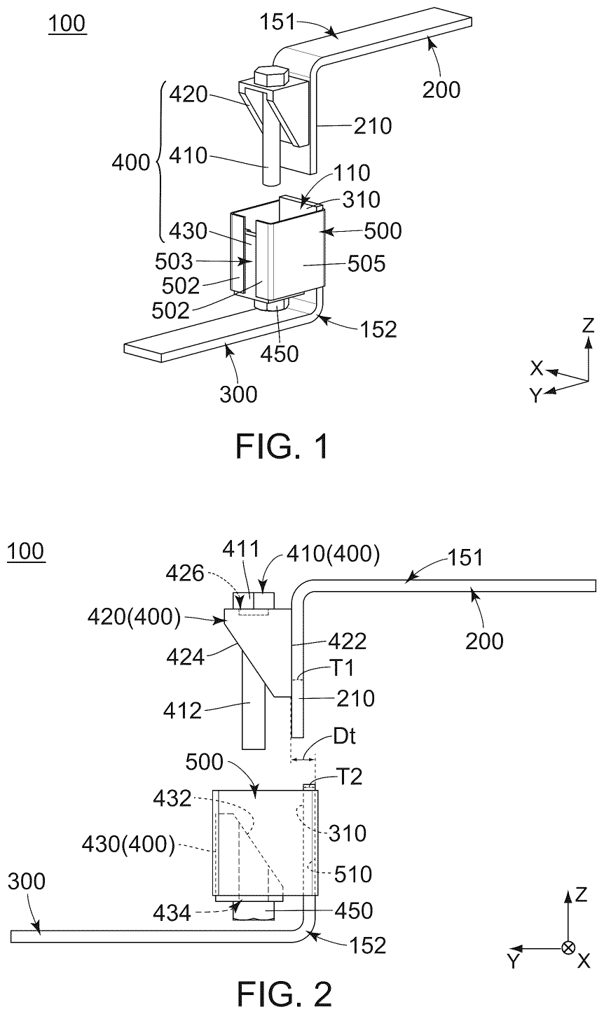

As shown in FIG. 1, a busbar connection body 100 according to a first embodiment of the present invention comprises a first busbar 200, a second busbar 300, a press mechanism 400 and a regulating member 500. The busbar connection body 100 of the present embodiment is, for example, used for connection of busbars in an electric automobile.

As shown in FIG. 1, the first busbar 200 of the present embodiment has a first contact portion 210. The first contact portion 210 extends in a first direction. The first contact portion 210 intersects with a second direction perpendicular to the first direction. Specifically, the first contact portion 210 has a flat-plate shape perpendicular to the second direction. In the present embodiment, the first direction is a Z-direction. The first direction is also referred to as an up-down direction. Specifically, it is assumed that upward is a positive Z-direction while downward is a negative Z-direction. In the present embodiment, the second direction is a Y-direction. The second direction is also referred to as a front-rear direction. Specifically, it is assumed that forward is a positive Y-direction while rearward is a negative Y-direction.

As shown in FIG. 1, the second busbar 300 of the present embodiment has a second contact portion 310. The second contact portion 310 extends in the first direction. The second contact portion 310 has a flat-plate shape perpendicular to the second direction.

As shown in FIG. 2, the press mechanism 400 of the present embodiment comprises a bolt 410, a first member 420 and a second member 430. The first busbar 200, the bolt 410 and the first member 420 form a first connection element 151.

Referring to FIG. 2, the bolt 410 of the present embodiment is made of metal. The bolt 410 has a shaft portion 412 extending in the first direction. The bolt 410 has a head portion 411. The head portion 411 defines an upper end of the bolt 410 in the up-down direction.

Referring to FIG. 2, the first member 420 of the present embodiment is made of insulator. However, the present invention is not limited thereto. The material of the first member 420 may be, for example, a conductive metal, and should be a material with sufficient strength. The first member 420 has a pressing portion 422 and a converting surface 424.

As shown in FIG. 2, the pressing portion 422 of the present embodiment is a plane perpendicular to the second direction. The pressing portion 422 is positioned rearward of the converting surface 424 in the front-rear direction. The pressing portion 422 defines a rear end of the first member 420 in the front-rear direction. The pressing portion 422 is fixed to the first busbar 200. In other words, the first member 420 is fixed to the first busbar 200. However, the present invention is not limited thereto. The first member 420 may not be fixed to the first busbar 200.

As shown in FIG. 2, the converting surface 424 of the present embodiment intersects with both the first direction and the second direction. More specifically, the converting surface 424 is a plane oblique to both the first direction and the second direction. However, the present invention is not limited thereto. The converting surface 424 may be a curved surface intersecting with both the first direction and the second direction. The converting surface 424 extends upward and forward. The converting surface 424 is positioned forward of the pressing portion 422 in the front-rear direction.

As shown in FIG. 2, the first member 420 is formed with a first piercing hole 426. The first piercing hole 426 is a hole piercing the first member 420 in the first direction. The shaft portion 412 of the bolt 410 is inserted into the first piercing hole 426. The first piercing hole 426 has an inner diameter greater than a diameter of the shaft portion 412 of the bolt 410. Accordingly, the shaft portion 412 of the bolt 410 is movable to some extent in the first piercing hole 426.

Referring to FIG. 1, the second member 430 of the present embodiment is made of insulator. However, the present invention is not limited thereto. The material of the second member 430 may be, for example, a conductive metal, and should be a material with sufficient strength. As shown in FIG. 2, the second member 430 has a force application portion 432.

As shown in FIG. 2, the force application portion 432 of the present embodiment intersects with both the first direction and the second direction. More in detail, the force application portion 432 is a plane oblique to both the first direction and the second direction. The force application portion 432 extends upward and forward. The force application portion 432 and the first direction make an angle equal to an angle which the converting surface 424 and the first direction make. The force application portion 432 and the second direction make an angle equal to an angle which the converting surface 424 and the second direction make.

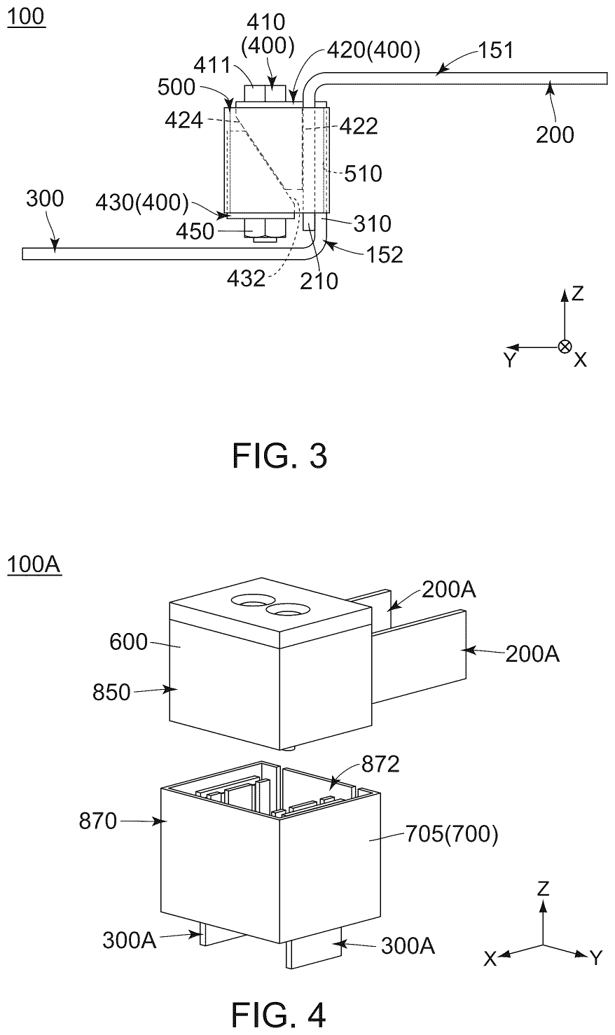

As shown in FIG. 2, the second member 430 is formed with a second piercing hole 434. The second piercing hole 434 is a hole piercing the second member 430 in the first direction. Referring to FIGS. 2 and 3, the shaft portion 412 of the bolt 410 is inserted into the second piercing hole 434. The second piercing hole 434 has an inner diameter greater than the diameter of the shaft portion 412 of the bolt 410. Accordingly, the shaft portion 412 of the bolt 410 is movable to some extent in the second piercing hole 434.

As shown in FIG. 1, the regulating member 500 of the present embodiment is a band. The second busbar 300 is fixed to the regulating member 500. The second member 430 is fixed to the regulating member 500.

As shown in FIG. 2, the regulating member 500 has a receiving portion 510.

As shown in FIG. 2, the receiving portion 510 of the present embodiment faces forward in the front-rear direction. The receiving portion 510 is a plane perpendicular to the second direction. As shown in FIG. 3, the receiving portion 510 is positioned apart from the pressing portion 422 in the second direction. The receiving portion 510 is fixed to the second contact portion 310.

As shown in FIG. 1, the regulating member 500 has two regulating portions 502 and two coupling portions 505.

As shown in FIG. 1, each of the regulating portions 502 of the present embodiment has a flat-plate shape perpendicular to the second direction. The regulating portion 502 defines a front end of the regulating member 500 in the front-rear direction. The second member 430 is fixed to the regulating portions 502.

As shown in FIG. 1, the coupling portions 505 of the present embodiment define opposite ends, respectively, of the regulating member 500 in a third direction. Each of the coupling portions 505 shown in the figure has a flat-plate shape perpendicular to the third direction. The coupling portion 505 couples the regulating portion 502 and the receiving portion 510 with each other. The coupling portions 505 correspond to the regulating portions 502, respectively. Each of the coupling portions 505 couples the corresponding regulating portion 502 and the receiving portion 510 with each other. In the present embodiment, the third direction is an X-direction.

As shown in FIG. 1, the regulating member 500 has a single slit 503.

As shown in FIG. 1, the slit 503 of the present embodiment extends in the first direction. The slit 503 is positioned between the two regulating portions 502 in the third direction. The slit 503 is positioned at the front end of the regulating member 500. However, the present invention is not limited thereto. Specifically, the regulating member 500 may have two slits 503, wherein one of the slits 503 is positioned at the front end of the regulating member 500 while a remaining one of the slits 503 is positioned at a rear end of the regulating member 500.

As shown in FIG. 1, the busbar connection body 100 is formed with an accommodation space 110 which accommodates both the first contact portion 210 and the second contact portion 310.

Referring to FIGS. 1 and 2, the accommodation space 110 of the present embodiment is positioned between the pressing portion 422 and the receiving portion 510. The accommodation space 110 is opened in the first direction. The accommodation space 110 extends in the first direction. The second contact portion 310 is accommodated in the accommodation space 110 along the first direction. However, the present invention is not limited thereto. Specifically, the busbar connection body 100 should be configured so that at least one of the first contact portion 210 and the second contact portion 310 is accommodated in the accommodation space 110 along the first direction.

As shown in FIG. 2, the busbar connection body 100 further comprises a nut 450.

As shown in FIG. 3, the nut 450 is positioned below the second member 430 in the up-down direction. Specifically, the nut 450 is positioned just below the second member 430 in the up-down direction. The nut 450 is positioned below the regulating member 500 in the up-down direction. The second busbar 300, the second member 430, the regulating member 500 and the nut 450 form a second connection element 152.

Referring to FIG. 3, the regulating member 500 holds the first member 420 and the second member 430 together under a state where the bolt 410 is fastened. Specifically, the regulating member 500 holds the first member 420 and the second member 430 together under a state where the bolt 410 is screwed into the nut 450. The regulating member 500 surrounds both the first member 420 and the second member 430 in a plane perpendicular to the first direction under the state where the bolt 410 is fastened. Specifically, the regulating member 500 surrounds both the first member 420 and the second member 430 in the plane perpendicular to the first direction under the state where the bolt 410 is screwed into the nut 450.

Hereinafter, an explanation will be made about an operation of connecting the first busbar 200 with the second busbar 300.

First, the first connection element 151 and the second connection element 152 are arranged in the first direction so that the first connection element 151 and the second connection element 152 take a state shown in FIG. 2. Next, the first connection element 151 and the second connection element 152 approach each other in the first direction. Then, the first connection element 151 and the second connection element 152 change their state into a state as follows: the first contact portion 210 of the first busbar 200 is accommodated in the accommodation space 110; the bolt 410 is inserted into the second piercing hole 434 of the second member 430; and the converting surface 424 of the first member 420 is brought into contact with the force application portion 432 of the second member 430. This state is referred to as a pre-fastening state. In the pre-fastening state, the second contact portion 310 is positioned between the first contact portion 210 and the receiving portion 510 in the accommodation space 110.

From the pre-fastening state, the bolt 410 is screwed into the nut 450. Then, the force application portion 432 presses the converting surface 424 in the first direction. The pressing of the force application portion 432 causes that the pressing portion 422 presses the first contact portion 210 against the second contact portion 310 in the second direction while the receiving portion 510 receives the second contact portion 310. Accordingly, the first busbar 200 and the second busbar 300 are connected to each other, and the connecting operation is completed.

More specifically, when the bolt 410 is screwed into the nut 450 in the pre-fastening state, the bolt 410 is moved downward and the first member 420 is pressed downward. Then, the force application portion 432 of the second member 430 presses the converting surface 424 of the first member 420 upward, while the converting surface 424 of the first member 420 exerts a reaction force, which resists the pressing of the force application portion 432, on the force application portion 432 of the second member 430 so that the converting surface 424 presses the force application portion 432 downward.

As described above, the converting surface 424 of the first member 420 extends upward and forward. Accordingly, the pressing of the force application portion 432 is converted by the converting surface 424 to a force which presses the first member 420 rearward in the front-rear direction. This causes that the first member 420 is moved rearward in the front-rear direction while the pressing portion 422 presses the first contact portion 210 rearward in the front-rear direction.

As described above, the force application portion 432 of the second member 430 extends upward and forward. Accordingly, the pressing of the converting surface 424 is converted by the force application portion 432 to a force which presses the second member 430 forward in the front-rear direction. This causes that second member 430 presses the regulating portions 502 of the regulating member 500 forward in the front-rear direction. The pressing against the regulating portions 502 applies a forward force in the front-rear direction to the receiving portion 510 via the coupling portions 505.

Thus, the first contact portion 210 and the second contact portion 310 are pressed in orientations in which the first contact portion 210 and the second contact portion 310 approach each other in the second direction, and the first busbar 200 and the second busbar 300 are connected to each other.

Summarizing the above, the force application portion 432 presses the converting surface 424 at least in the first direction when the bolt 410 is fastened under a state where the second contact portion 310 is positioned between the first contact portion 210 and the receiving portion 510 in the accommodation space 110. Additionally, when the force application portion 432 presses the converting surface 424, the pressing portion 422 presses the first contact portion 210 against the second contact portion 310 in the second direction while the receiving portion 510 receives the second contact portion 310.

The busbar connection body 100 of the present embodiment is configured so that the first direction, in which the shaft portion 412 of the bolt 410 for fastening the first busbar 200 and the second busbar 300 to each other extends, is perpendicular to the second direction in which the first contact portion 210 is pressed against the second contact portion 310. In other words, the busbar connection body 100 of the present embodiment is configured so that the direction, in which the shaft portion 412 of the bolt 410 extends, coincides with the direction in which each of the first contact portion 210 and the second contact portion 310 extends. Thus, the busbar connection body 100 of the present embodiment is configured so that space for operation of fastening the first busbar 200 and the second busbar 300 to each other by the bolt 410 is provided along the direction in which each of the first contact portion 210 and the second contact portion 310 extends. Consequently, the busbar connection body 100 of the present embodiment does not unnecessarily restrict placement of components around the busbar connection body 100.

Referring to FIG. 2, a distance Dt between the pressing portion 422 and the receiving portion 510 in the second direction before the bolt 410 is fastened is greater than a sum of a thickness T1 of the first contact portion 210 and a thickness T2 of the second contact portion 310. This reduces an insertion force of the first contact portion 210 of the first busbar 200 when the first contact portion 210 of the first busbar 200 is inserted into the accommodation space 110.

### Second Embodiment

As shown in FIG. 8, a busbar connection body 100A according to a second embodiment of the present invention comprises two first busbars 200A, two second busbars 300A, two press mechanisms 400A and two regulating members 500A. However, the present invention is not limited thereto. Specifically, the busbar connection body 100A should comprise the single first busbar 200A, the single second busbar 300A, the single press mechanism 400A and the single regulating member 500A. The busbar connection body 100A of the present embodiment is, for example, used for connection of busbars in an electric automobile. As for directions and orientations in the present embodiment, expressions same as those of the first embodiment will be used hereinbelow.

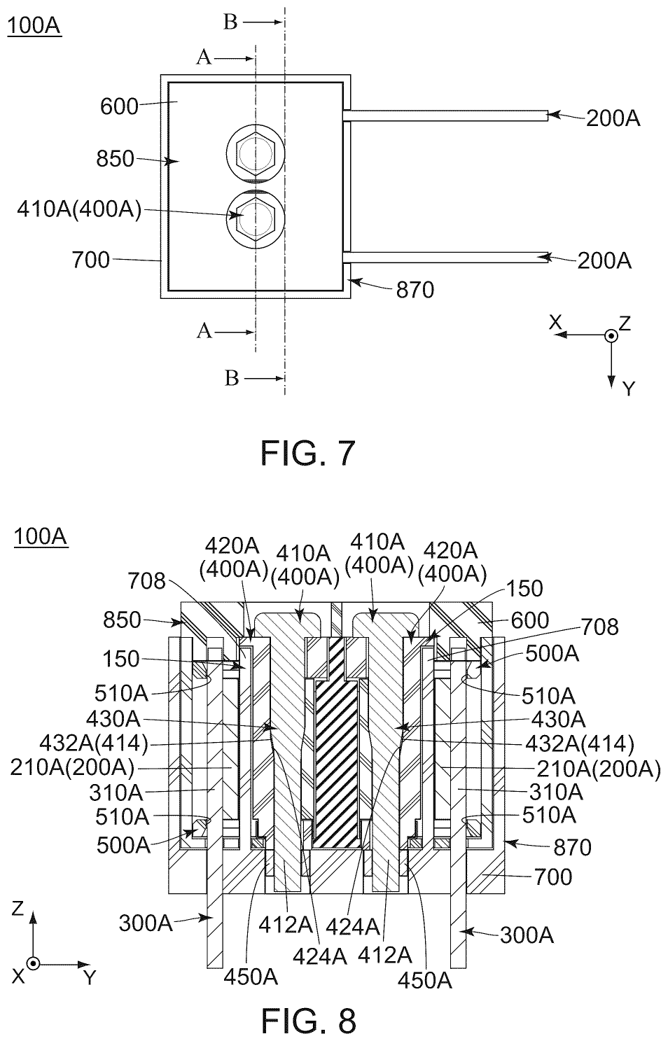

As shown in FIG. 12, each of the first busbars 200A of the present embodiment has a first contact portion 210A. The first contact portion 210A extends in the third direction. The first contact portion 210A has a flat-plate shape perpendicular to the second direction. As shown in FIG. 7, the two first busbars 200A are arranged in the second direction.

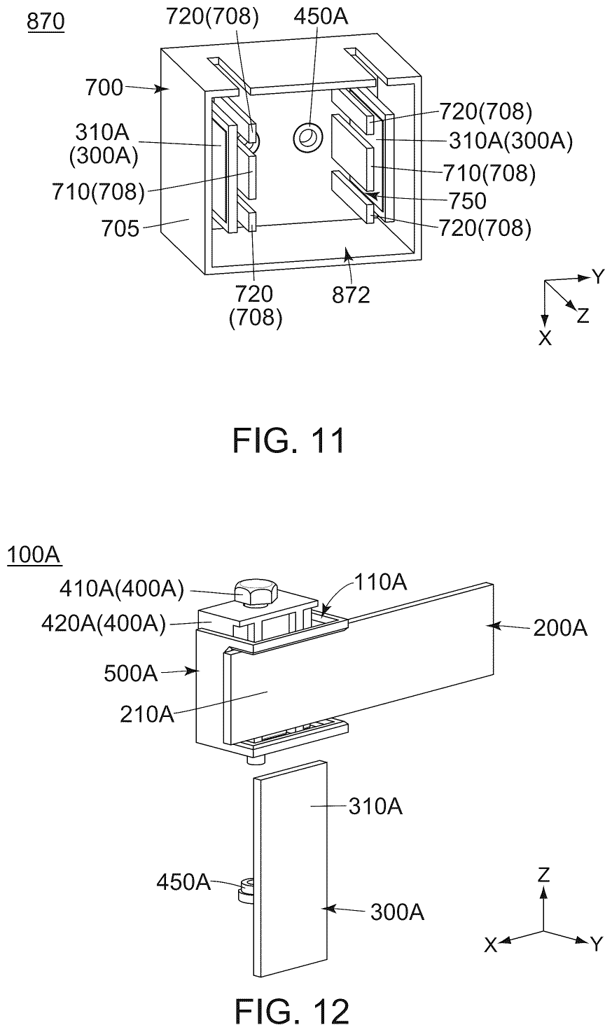

As shown in FIG. 12, each of the second busbars 300A of the present embodiment has a second contact portion 310A. The second contact portion 310A extends in the first direction. The second contact portion 310A has a flat-plate shape perpendicular to the second direction. As shown in FIG. 11, the two second busbars 300A are arranged in the second direction.

As shown in FIG. 18, each of the press mechanisms 400A of the present embodiment has a bolt 410A, a first member 420A and a second member 430A.

Referring to FIG. 18, the bolt 410A of the present embodiment is made of metal. The bolt 410A has a shaft portion 412A extending in the first direction. The bolt 410A has a head portion 411A. The head portion 411A defines an upper end of the bolt 410A in the up-down direction. The bolt 410A also serves as the second member 430A. The bolt 410A is formed with a conical base portion 414. The conical base portion 414 is positioned around a middle of the bolt 410A in the first direction. The conical base portion 414 functions as a force application portion 432A as described below.

As shown in FIG. 18, the bolt 410A further has a first shaft portion 413 and a second shaft portion 415. The first shaft portion 413 has a diameter greater than a diameter of the second shaft portion 415. The conical base portion 414 is positioned between the first shaft portion 413 and the second shaft portion 415 in the first direction. The conical base portion 414 is tapered toward the second shaft portion 415.

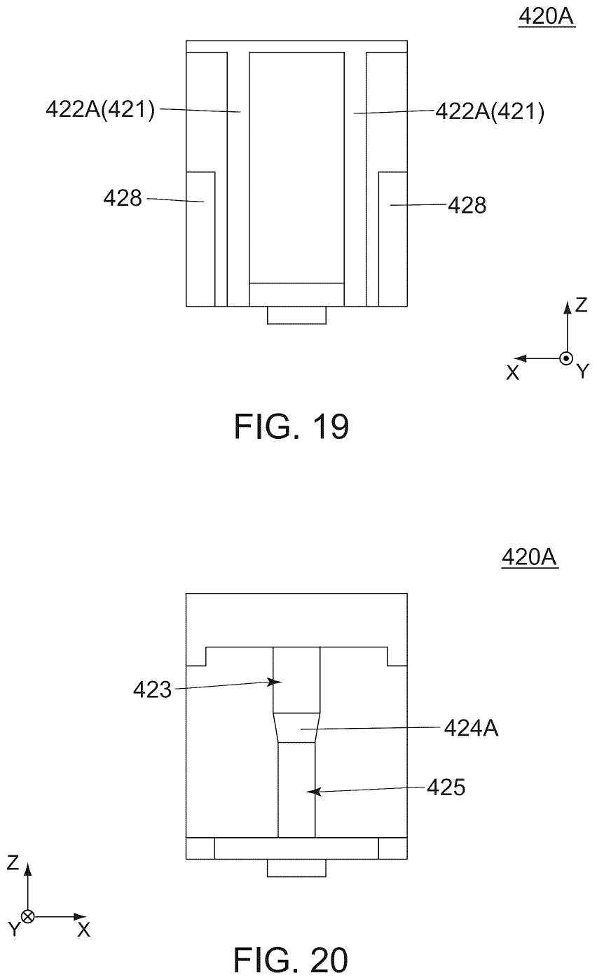

Referring to FIG. 19, the first member 420A of the present embodiment is made of insulator. However, the present invention is not limited thereto. The material of the first member 420A may be, for example, a conductive metal, and should be a material with sufficient strength. Referring to FIGS. 14 and 16, the first member 420A is movable in the second direction. The first member 420A has pressing portions 422A and a converting surface 424A.

As shown in FIG. 22, each of the pressing portions 422A of the present embodiment is a plane perpendicular to the second direction. Each of the pressing portions 422A faces outward in the second direction. As shown in FIG. 16, each of the pressing portions 422A is positioned outward of the converting surface 424A in the second direction. Each of the pressing portions 422A defines an outer end of the first member 420A in the second direction. Referring to FIGS. 14 and 16, none of the pressing portions 422A are fixed to the first busbar 200A. In other words, the first member 420A is not fixed to the first busbar 200A.

As shown in FIG. 16, the converting surface 424A of the present embodiment intersects with both the first direction and the second direction. More specifically, the converting surface 424A is a curved surface intersecting with both the first direction and the second direction. However, the present invention is not limited thereto. The converting surface 424A may be a plane oblique to both the first direction and the second direction. The converting surface 424A extends upward in the up-down direction and outward in the second direction. The converting surface 424A is positioned inward of any of the pressing portions 422A in the second direction. The converting surface 424A is recessed outward in the second direction. The converting surface 424A has an arc-shaped cross-section in a plane perpendicular to the first direction.

As shown in FIG. 16, the conical base portion 414 is positioned at the same position as the converting surface 424A in the first direction under a state where the bolt 410A is not fastened. As shown in FIG. 14, a lower end of the conical base portion 414 is positioned below a lower end of the converting surface 424A in the up-down direction under a state where the bolt 410A is fastened.

As shown in FIG. 20, the first member 420A has a first recess portion 423 and a second recess portion 425.

Referring to FIG. 16, the first recess portion 423 of the present embodiment is recessed outward in the second direction. The first recess portion 423 has a semi-circular cross-section in the plane perpendicular to the first direction. The first recess portion 423 is positioned above the converting surface 424A in the up-down direction. The first recess portion 423 is positioned above the second recess portion 425 in the up-down direction. A part of the first shaft portion 413 of the bolt 410A is positioned in the first recess portion 423 under the state where the bolt 410A is not fastened. The conical base portion 414 of the bolt 410A is not positioned in the first recess portion 423 under the state where the bolt 410A is not fastened.

Referring to FIG. 16, the second recess portion 425 of the present embodiment is recessed outward in the second direction. The second recess portion 425 has a semi-circular cross-section in the plane perpendicular to the first direction. The second recess portion 425 is positioned below the converting surface 424A in the up-down direction. The second recess portion 425 is positioned below the first recess portion 423 in the up-down direction. The radius of curvature of the semicircle of the cross-section of the first recess portion 423 is greater than the radius of curvature of the semicircle of the cross-section of the second recess portion 425. The converting surface 424A is positioned between the first recess portion 423 and the second recess portion 425 in the first direction. A part of the second shaft portion 415 of the bolt 410A is positioned in the second recess portion 425 under the state where the bolt 410A is not fastened. The conical base portion 414 of the bolt 410A is not positioned in the second recess portion 425 under the state where the bolt 410A is not fastened. As shown in FIG. 14, a part of the conical base portion 414 of the bolt 410A is positioned in the second recess portion 425 under the state where the bolt 410A is fastened. The lower end of the conical base portion 414 of the bolt 410A is positioned below an upper end of the second recess portion 425 in the up-down direction under the state where the bolt 410A is fastened.

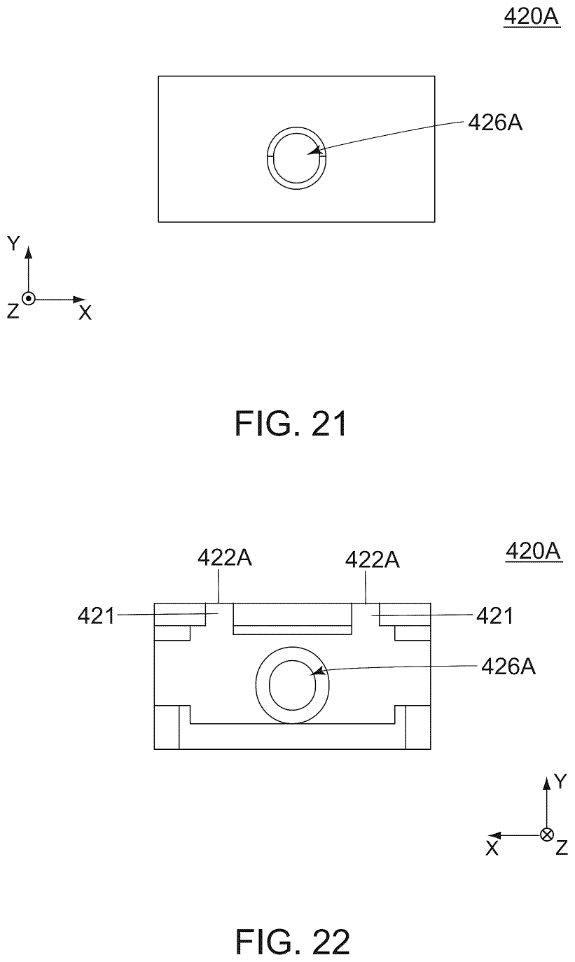

As shown in FIG. 21, the first member 420A is formed with a hole 426A. The hole 426A pierces the first member 420A in the first direction. As shown in FIG. 16, the shaft portion 412A of the bolt 410A is inserted into the hole 426A.

As shown in FIG. 22, the first member 420A has two protruding portions 421. The pressing portion 422A is an outer end surface of the protruding portion 421 in the second direction.

As shown in FIG. 19, the first member 420A has two first-member-side spring receivers 428.

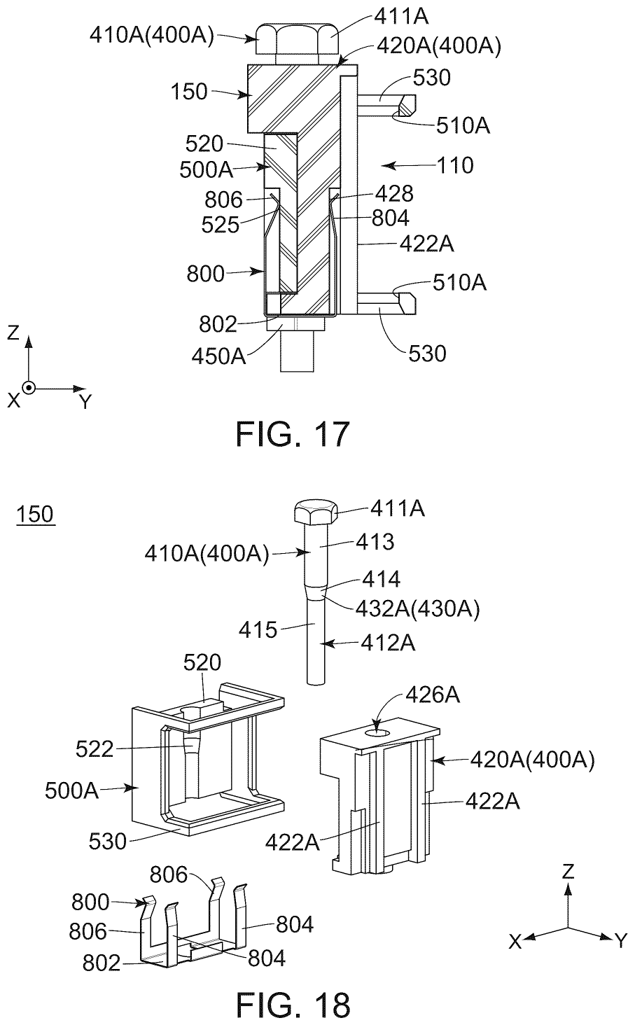

As shown in FIG. 17, each of the first-member-side spring receivers 428 of the present embodiment is a plane perpendicular to the second direction. Each of the first-member-side spring receivers 428 faces outward in the second direction. Referring to FIGS. 16 and 17, each of the first-member-side spring receivers 428 is positioned between the hole 426A and each of the pressing portions 422A in the second direction. Each of the first-member-side spring receivers 428 is positioned outward of the hole 426A in the second direction. Each of the first-member-side spring receivers 428 is positioned inward of any of the pressing portions 422A in the second direction.

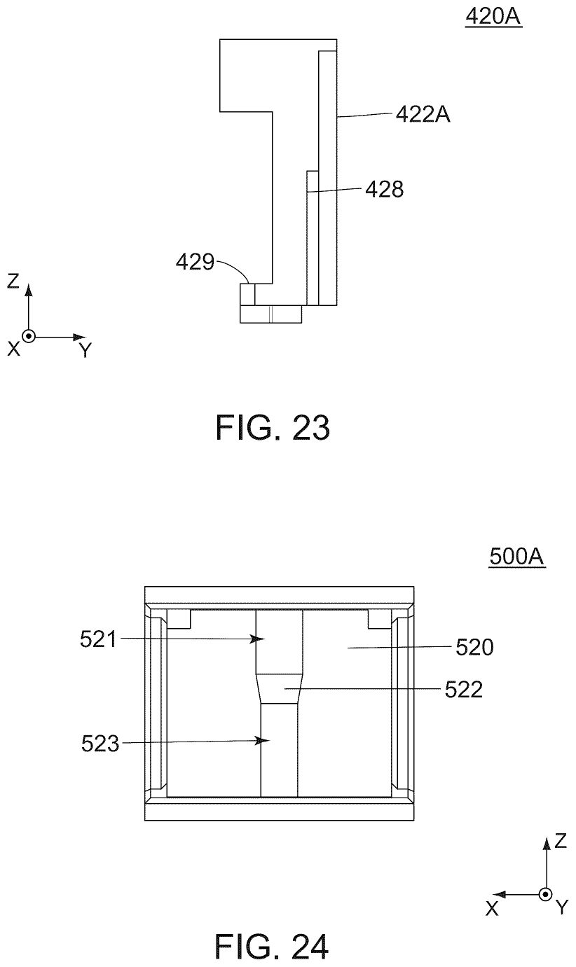

As shown in FIG. 23, the first member 420A has a regulation portion 429.

As shown in FIG. 16, the regulation portion 429 of the present embodiment is a plane perpendicular to the first direction. The regulation portion 429 is positioned around a lower end of the first member 420A in the up-down direction. The regulation portion 429 faces upward in the up-down direction.

As shown in FIG. 18, the second member 430A of the present embodiment has the force application portion 432A.

As shown in FIG. 16, the force application portion 432A of the present embodiment is positioned around a middle of the second member 430A in the first direction.

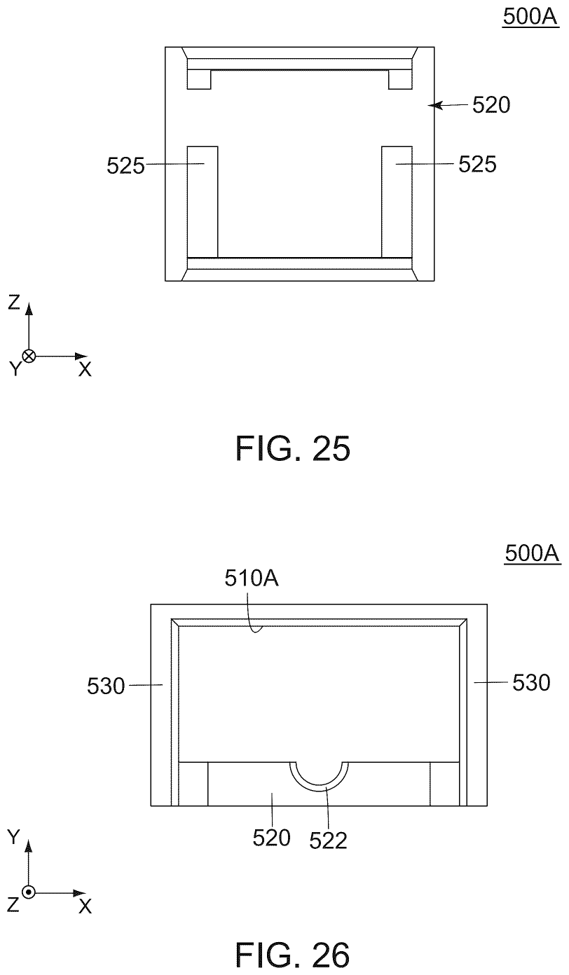

Referring to FIG. 26, the regulating member 500A of the present embodiment is made of insulator. Referring to FIGS. 14 and 16, the regulating member 500A is movable in the second direction. The regulating member 500A has a receiving portion 510A.

As shown in FIG. 16, the receiving portion 510A of the present embodiment faces inward in the second direction. The receiving portion 510A is a plane perpendicular to the second direction. The receiving portion 510A is positioned around an outer end of the regulating member 500A in the second direction. The receiving portion 510A is positioned apart from any of the pressing portions 422A in the second direction. Specifically, in the second direction, the receiving portion 510A is positioned outward of any of the pressing portions 422A and apart from any of the pressing portions 422A.

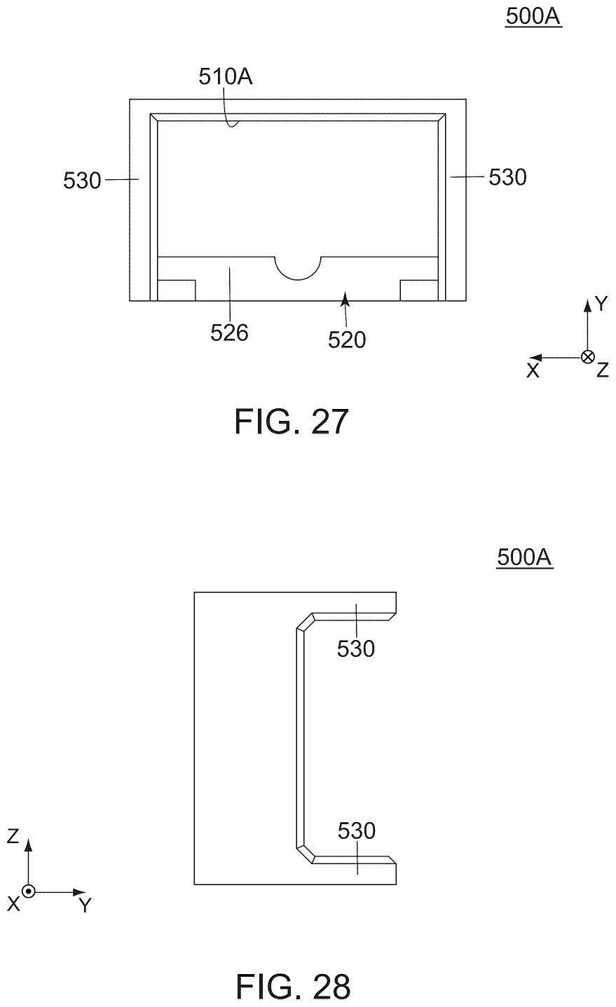

As shown in FIGS. 27 and 28, the regulating member 500A further has a main portion 520 and arm portions 530.

As shown in FIG. 16, the main portion 520 of the present embodiment defines an inner end of the regulating member 500A in the second direction. The main portion 520 is formed with a facing taper portion 522.

As shown in FIG. 16, the facing taper portion 522 of the present embodiment intersects with both the first direction and the second direction perpendicular to the first direction. More specifically, the facing taper portion 522 is a curved surface intersecting with both the first direction and the second direction. However, the present invention is not limited thereto. The facing taper portion 522 may be a plane oblique to both the first direction and the second direction. The facing taper portion 522 extends upward in the up-down direction and inward in the second direction. The facing taper portion 522 is recessed inward in the second direction. The facing taper portion 522 has an arc-shaped cross-section in the plane perpendicular to the first direction. The facing taper portion 522 is positioned inward of the converting surface 424A in the second direction.

Referring to FIGS. 14 and 16, when the bolt 410A is fastened, the conical base portion 414 presses the converting surface 424A so that each of the pressing portions 422A is moved toward the receiving portion 510A. Additionally, when the bolt 410A is fastened, the conical base portion 414 presses the facing taper portion 522 so that the receiving portion 510A is moved toward the pressing portions 422A.

As shown in FIG. 24, the main portion 520 is formed with a first receive portion 521 and a second receive portion 523.

Referring to FIG. 16, the first receive portion 521 of the present embodiment is recessed inward in the second direction. The first receive portion 521 has a semi-circular cross-section in the plane perpendicular to the first direction. The first receive portion 521 is positioned above the facing taper portion 522 in the up-down direction. The first receive portion 521 is positioned above the second receive portion 523 in the up-down direction. A part of the first shaft portion 413 of the bolt 410A is positioned in the first receive portion 521 when the bolt 410A is not fastened. The conical base portion 414 of the bolt 410A is not positioned in the first receive portion 521 when the bolt 410A is not fastened.

Referring to FIG. 16, the second receive portion 523 of the present embodiment is recessed inward in the second direction. The second receive portion 523 has a semi-circular cross-section in the plane perpendicular to the first direction. The second receive portion 523 is positioned below the facing taper portion 522 in the up-down direction. The second receive portion 523 is positioned below the first receive portion 521 in the up-down direction. The radius of curvature of the semicircle of the cross-section of the first receive portion 521 is greater than the radius of curvature of the semicircle of the cross-section of the second receive portion 523. The facing taper portion 522 is positioned between the first receive portion 521 and the second receive portion 523 in the first direction. A part of the second shaft portion 415 of the bolt 410A is positioned in the second receive portion 523 when the bolt 410A is not fastened. The conical base portion 414 of the bolt 410A is not positioned in the second receive portion 523 when the bolt 410A is not fastened. As shown in FIG. 14, a part of the conical base portion 414 of the bolt 410A is positioned in the second receive portion 523 when the bolt 410A is fastened. The lower end of the conical base portion 414 of the bolt 410A is positioned below an upper end of the second receive portion 523 in the up-down direction when the bolt 410A is fastened.

As shown in FIG. 25, the main portion 520 has two regulating-member-side spring receivers 525.

As shown in FIG. 17, each of the regulating-member-side spring receivers 525 of the present embodiment is a plane perpendicular to the second direction. Each of the regulating-member-side spring receivers 525 faces inward in the second direction. Each of the regulating-member-side spring receivers 525 is positioned around the inner end of the regulating member 500A in the second direction.

As shown in FIG. 27, the main portion 520 has a regulated portion 526.

As shown in FIG. 27, the regulated portion 526 of the present embodiment is a plane perpendicular to the first direction. The regulated portion 526 faces downward in the up-down direction. As shown in FIG. 14, the regulated portion 526 is positioned around a lower end of the regulating member 500A in the up-down direction. The regulated portion 526 faces the regulation portion 429 in the first direction. The regulated portion 526 is positioned above the regulation portion 429 in the up-down direction.

Referring to FIG. 16, each of the arm portions 530 of the present embodiment extends from the main portion 520. Specifically, each of the arm portions 530 extends outward in the second direction from the main portion 520. Each of the arm portions 530 supports the receiving portion 510A.

As shown in FIG. 12, the busbar connection body 100A is formed with accommodation spaces 110A each of which accommodates both the first contact portion 210A and the second contact portion 310A.

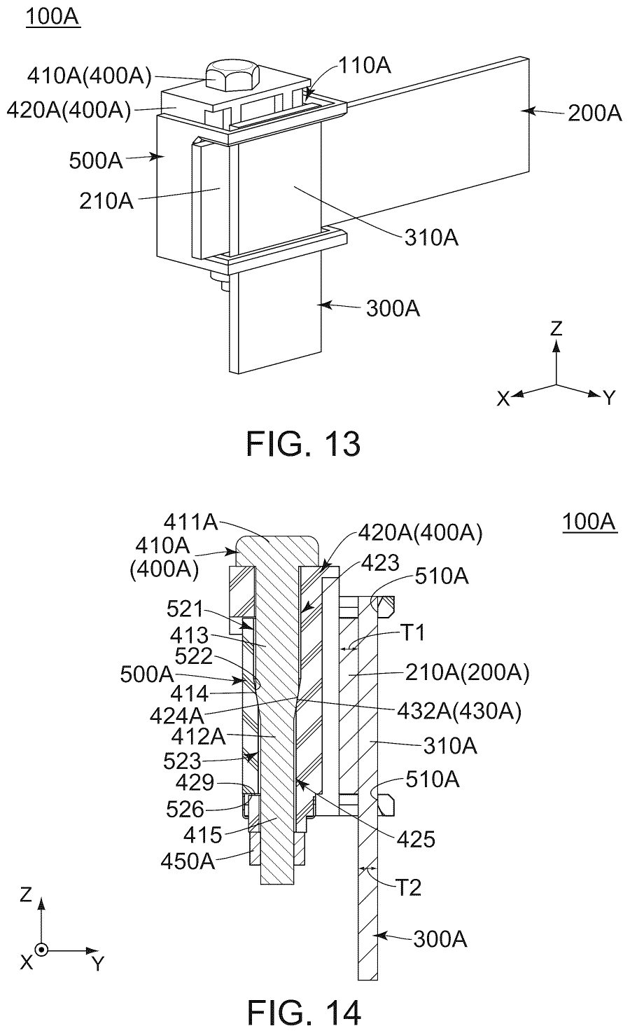

As shown in FIG. 16, the accommodation space 110A of the present embodiment is positioned between each of the pressing portions 422A and the receiving portion 510A. The accommodation space 110A is opened in the first direction. The accommodation space 110A is opened in the third direction. The accommodation space 110A extends in the first direction. The accommodation space 110A extends in the third direction. As shown in FIG. 13, the second contact portion 310A is accommodated in the accommodation space 110A along the first direction. However, the present invention is not limited thereto. Specifically, the busbar connection body 100A should be configured so that at least one of the first contact portion 210A and the second contact portion 310A is accommodated in the accommodation space 110A along the first direction.

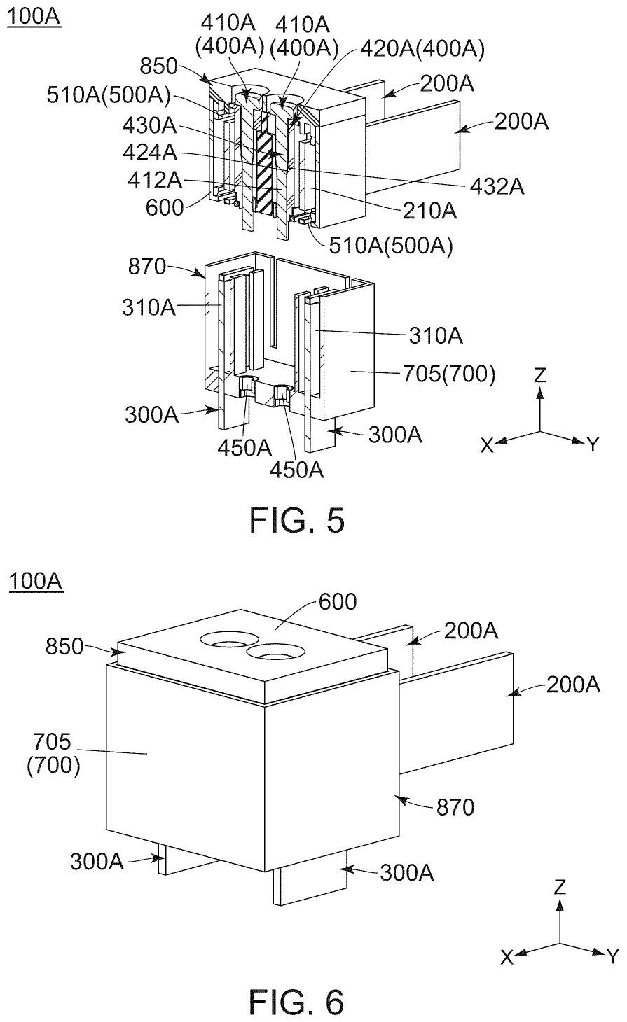

As shown in FIG. 5, the busbar connection body 100A further comprises nuts 450A.

As shown in FIG. 14, the nut 450A is positioned below the first member 420A in the up-down direction. Specifically, the nut 450A is positioned just below the first member 420A in the up-down direction. The nut 450A is positioned below the second member 430A in the up-down direction. Specifically, the nut 450A is positioned just below the second member 430A in the up-down direction. The nut 450A is positioned below the regulating member 500A in the up-down direction. The nut 450A is positioned just below the regulating member 500A in the up-down direction. The first member 420A is sandwiched between the head portion 411A of the bolt 410A and the nut 450A when the bolt 410A is screwed into the nut 450A.

As shown in FIG. 4, the busbar connection body 100A further comprises a first housing 600 and a second housing 700. However, the present invention is not limited thereto. The busbar connection body 100A may comprise no first housing 600. Additionally, the busbar connection body 100A may comprise no second housing 700.

Referring to FIG. 5, the first housing 600 of the present embodiment is made of insulator. The first housing 600 holds all of the first busbars 200A, the press mechanisms 400A and the regulating members 500A.

As shown in FIG. 10, the first housing 600 has two insertion holes 610.

Referring to FIG. 10, each of the insertion holes 610 of the present embodiment is positioned at a lower end of the first housing 600 in the up-down direction. The insertion holes 610 correspond to the second busbars 300A, respectively. Each of the insertion holes 610 has a slit-like shape extending in the third direction. This prevents an operator from accidentally inserting his/her finger into the insertion hole 610 in an operation of connecting the first busbars 200A and the second busbars 300A.

As shown in FIG. 10, the first housing 600 has two additional insertion holes 615.

Referring to FIG. 10, each of the additional insertion holes 615 of the present embodiment is positioned at the lower end of the first housing 600 in the up-down direction. Each of the additional insertion holes 615 has a slit-like shape extending in the third direction. The additional insertion holes 615 correspond to the insertion holes 610, respectively. Each of the additional insertion holes 615 is positioned inward of the corresponding insertion hole 610 in the second direction.

Referring to FIG. 5, the second housing 700 of the present embodiment is made of insulator. The second housing 700 holds the second busbars 300A.

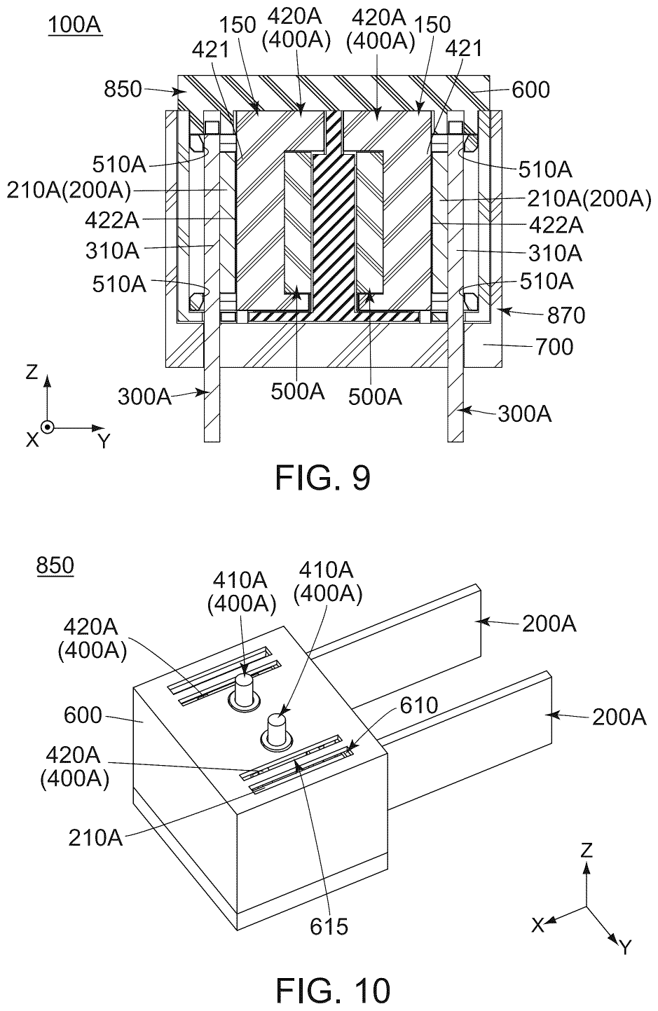

Referring to FIGS. 8 and 9, the first contact portions 210A are pressed against the second contact portions 310A, respectively, when the first housing 600 is mated with the second housing 700 and the bolts 410A are fastened. Specifically, the first contact portions 210A are pressed against the second contact portions 310A, respectively, when the first housing 600 is mated with the second housing 700 and the bolts 410A are screwed into the nuts 450A, respectively.

As shown in FIG. 11, the second housing 700 has an outer wall 705.

As shown in FIG. 11, the outer wall 705 of the present embodiment defines an outer end of the second housing 700 in a direction perpendicular to the first direction. The outer wall 705 defines opposite ends of the second housing 700 in the second direction. The outer wall 705 defines opposite ends of the second housing 700 in the third direction. The second contact portion 310A of each of the second busbars 300A is surrounded by the outer wall 705 in the plane perpendicular to the up-down direction. This prevents the operator from accidentally making contact with an outer surface of the second contact portion 310A of each of the second busbars 300A in the second direction when the operator handles the busbar connection body 100A.

As shown in FIG. 11, the second housing 700 has two partition portions 708.

As shown in FIG. 11, the partition portions 708 of the present embodiment correspond to the second busbars 300A, respectively. Each of the partition portions 708 is positioned inward of the corresponding second busbar 300A in the second direction. This prevents the operator from accidentally making contact with an inner surface of the second contact portion 310A of each of the second busbars 300A in the second direction when the operator handles the busbar connection body 100A. Referring to FIGS. 10 and 11, the partition portions 708 correspond to the additional insertion holes 615, respectively. Each of the partition portions 708 is inserted into the corresponding additional insertion hole 615 when the first housing 600 is mated with the second housing 700. As shown in FIG. 8, the partition portions 708 correspond to the first busbars 200A, respectively. The partition portions 708 correspond to the bolts 410A, respectively. The partition portions 708 correspond to the first members 420A, respectively. The partition portions 708 correspond to the second members 430A, respectively. The partition portions 708 correspond to the regulating members 500A, respectively.

As shown in FIG. 11, each of the partition portions 708 consists of a first partition portion 710 and two second partition portions 720. The first partition portion 710 and the second partition portions 720 are arranged in the third direction. The first partition portions 710 is positioned between the two second partition portions 720 in the third direction. The first partition portions 710 and the second partition portion 720 are arranged with a space 750 left therebetween.

As shown in FIG. 5, the busbar connection body 100A comprises a first structure 850 and a second structure 870. Referring to FIGS. 4 and 6, the first structure 850 and the second structure 870 are mateable with each other along the first direction.

As shown in FIG. 5, the first structure 850 of the present embodiment comprises the first housing 600, the two first busbars 200A, the two press mechanisms 400A and the two regulating members 500A. In the present application, the first structure 850 is referred to as a structure 850. However, the present invention is not limited thereto. Specifically, the structure 850 should comprise the first housing 600, the single first busbar 200A, the single press mechanism 400A and the single regulating member 500A.

As shown in FIG. 5, the second structure 870 of the present embodiment comprises the two second busbars 300A, the two nuts 450A and the second housing 700. However, the present invention is not limited thereto. Specifically, the second structure 870 should comprise the single second busbar 300A, the single nut 450A and the second housing 700.

Referring to FIGS. 9 and 11, the protruding portion 421 of the first member 420A is positioned between the first partition portion 710 and the second partition portion 720 of the corresponding partition portion 708 when the first structure 850 and the second structure 870 are mated with each other. Specifically, at least a part of the protruding portion 421 of the first member 420A is positioned in the space 750 of the corresponding partition portion 708 when the first structure 850 and the second structure 870 are mated with each other.

As shown in FIG. 11, the second structure 870 has a receiver portion 872. The receiver portion 872 is a space recessed downward in the up-down direction.

As shown in FIG. 18, the busbar connection body 100A further comprises spring members 800.

Referring to FIG. 18, each of the spring members 800 of the present embodiment is made of metal. As shown in FIGS. 16 and 17, the spring member 800 sandwiches both the main portion 520 and the first member 420A so that the main portion 520 is urged toward the converting surface 424A. Specifically, each of the first member 420A and the regulating member 500A is sandwiched by the spring member 800, and thereby the first member 420A is pressed inward in the second direction while the regulating member 500A is pressed outward in the second direction.

As shown in FIG. 18, each of the spring members 800 has a base portion 802 and four resilient pieces 804, 806. The base portion 802 defines a lower end of the spring member 800 in the up-down direction. Each of the resilient pieces 804, 806 is resiliently deformable. Each of the resilient pieces 804, 806 extends in the first direction from the base portion 802. Specifically, each of the resilient pieces 804, 806 extends upward in the up-down direction from the base portion 802. Each of the resilient pieces 804 is positioned outward of any of the resilient pieces 806 in the second direction. As shown in FIG. 17, an inner end of the resilient piece 804 in the second direction is in contact with the first-member-side spring receiver 428. An outer end of the resilient piece 806 in the second direction is in contact with the regulating-member-side spring receiver 525.

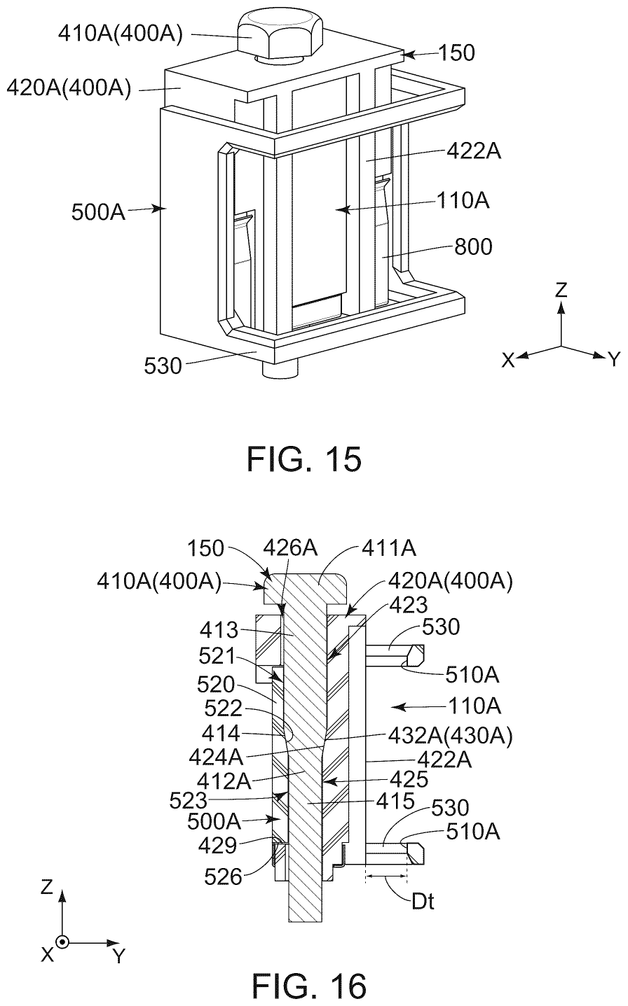

Referring to FIGS. 15 and 17, the press mechanism 400A, the regulating member 500A and the spring member 800 form a connection component 150. Referring to FIG. 8, the busbar connection body 100A comprises two of the connection components 150.

Hereinafter, an explanation will be made about the connecting operation of the first busbars 200A with the second busbars 300A.

First, the first structure 850 and the second structure 870 are arranged in the first direction so that the first structure 850 and the second structure 870 take a state shown in FIG. 4. Next, the first structure 850 and the second structure 870 approach each other in the first direction. Then, the first structure 850 and the second structure 870 change their state into a state as follows: a part of the first structure 850 is received in the receiver portion 872 of the second structure 870; the second contact portions 310A of the second structure 870 are accommodated in the accommodation spaces 110A via the insertion holes 610, respectively, of the first structure 850; the partition portions 708 of the second structure 870 are accommodated in the first housing 600 via the additional insertion holes 615, respectively, of the first structure 850; and the bolts 410A are inserted into holes of the nuts 450A, respectively. This state is referred to as a pre-fastening state. In the pre-fastening state, the second contact portion 310A is positioned between the first contact portion 210A and the receiving portion 510A in the accommodation space 110A.

From the pre-fastening state, the bolts 410A are screwed into the nuts 450A, respectively. Then, the force application portion 432A presses the converting surface 424A in the first direction. The pressing of the force application portion 432A causes that each of the pressing portion 422A presses the first contact portion 210A against the second contact portion 310A in the second direction while the receiving portion 510A receives the second contact portion 310A. Accordingly, the first busbar 200A and the second busbar 300A are connected to each other, and the connecting operation is completed.

More specifically, when the bolt 410A is screwed into the nut 450A in the pre-fastening state, the bolt 410A is moved downward. Then, the force application portion 432A of the bolt 410A presses the converting surface 424A of the first member 420A downward while the conical base portion 414 of the bolt 410A presses the facing taper portion 522 of the regulating member 500A downward.

As described above, the converting surface 424A of the first member 420A extends upward in the up-down direction and outward in the second direction. Accordingly, the pressing of the force application portion 432A is converted by the converting surface 424A to a force which presses the first member 420A outward in the second direction. This causes that the first member 420A is moved outward in the second direction while each of the pressing portions 422A presses the first contact portion 210A outward in the second direction.

As described above, the facing taper portion 522 of the regulating member 500A extends upward in the up-down direction and inward in the second direction. Accordingly, the pressing of the conical base portion 414 is converted by the facing taper portion 522 to a force which presses the regulating member 500A inward in the second direction. This causes that the regulating member 500A is moved inward in the second direction while the receiving portion 510A presses the second contact portion 310A inward in the second direction.

Thus, the first contact portion 210A and the second contact portion 310A are pressed in orientations in which the first contact portion 210A and the second contact portion 310A approach each other in the second direction, and the first busbar 200A and the second busbar 300A are connected to each other.

Summarizing the above, the force application portion 432A presses the converting surface 424A at least in the first direction when the bolt 410A is fastened under a state where the second contact portion 310A is positioned between the first contact portion 210A and the receiving portion 510A in the accommodation space 110A. Additionally, when the force application portion 432A presses the converting surface 424A, each of the pressing portions 422A presses the first contact portion 210A against the second contact portion 310A in the second direction while the receiving portion 510A receives the second contact portion 310A.

The busbar connection body 100A of the present embodiment is configured so that the first direction, in which the shaft portion 412A of the bolt 410A for fastening the first busbar 200A and the second busbar 300A to each other extends, is perpendicular to the second direction in which the first contact portion 210A is pressed against the second contact portion 310A. In other words, the busbar connection body 100A of the present embodiment is configured so that the direction, in which the shaft portion 412A of the bolt 410A extends, coincides with the direction in which the second contact portion 310A extends. Thus, the busbar connection body 100A of the present embodiment is configured so that space for operation of fastening the first busbar 200A and the second busbar 300A to each other by the bolt 410A is provided along the direction in which the second contact portion 310A extends. Consequently, the busbar connection body 100A of the present embodiment does not unnecessarily restrict placement of components around the busbar connection body 100A.

Referring to FIGS. 14 and 16, a distance Dt between each of the pressing portions 422A and the receiving portion 510A in the second direction before the bolt 410A is fastened is greater than a sum of a thickness T1 of the first contact portion 210A and a thickness T2 of the second contact portion 310A. This reduces an insertion force of the second busbar 300A of the second structure 870 when the second busbar 300A of the second structure 870 is inserted into the accommodation space 110A of the first structure 850.

### Third Embodiment

As shown in FIG. 36, a busbar connection body 100B according to a third embodiment of the present invention comprises two first busbars 200B, two second busbars 300B, two press mechanisms 400B and two regulating members 500B. However, the present invention is not limited thereto. Specifically, the busbar connection body 100B should comprise the single first busbar 200B, the single second busbar 300B, the single press mechanism 400B and the single regulating member 500B. The first busbar 200B and the second busbar 300B of the present embodiment have configurations same as those of the first busbar 200A and the second busbar 300A of the second embodiment. Accordingly, a detail explanation thereabout will be omitted. The busbar connection body 100B of the present embodiment is, for example, used for connection of busbars in an electric automobile. As for directions and orientations in the present embodiment, expressions same as those of the first embodiment will be used hereinbelow.

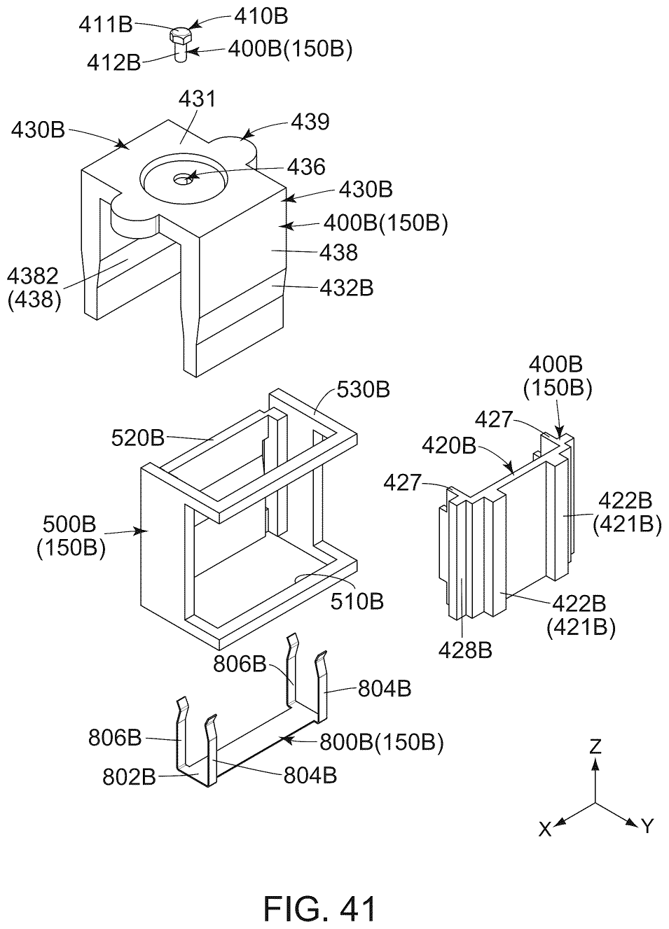

As shown in FIG. 41, the press mechanism 400B of the present embodiment has a bolt 410B, a first member 420B and a second member 430B.

Referring to FIG. 41, the bolt 410B of the present embodiment is made of metal. The bolt 410B has a shaft portion 412B extending in the first direction. The bolt 410B has a head portion 411B. The head portion 411B defines an upper end of the bolt 410B in the up-down direction. As shown in FIG. 32, the bolt 410B is positioned at a middle of the busbar connection body 100B in the second direction.

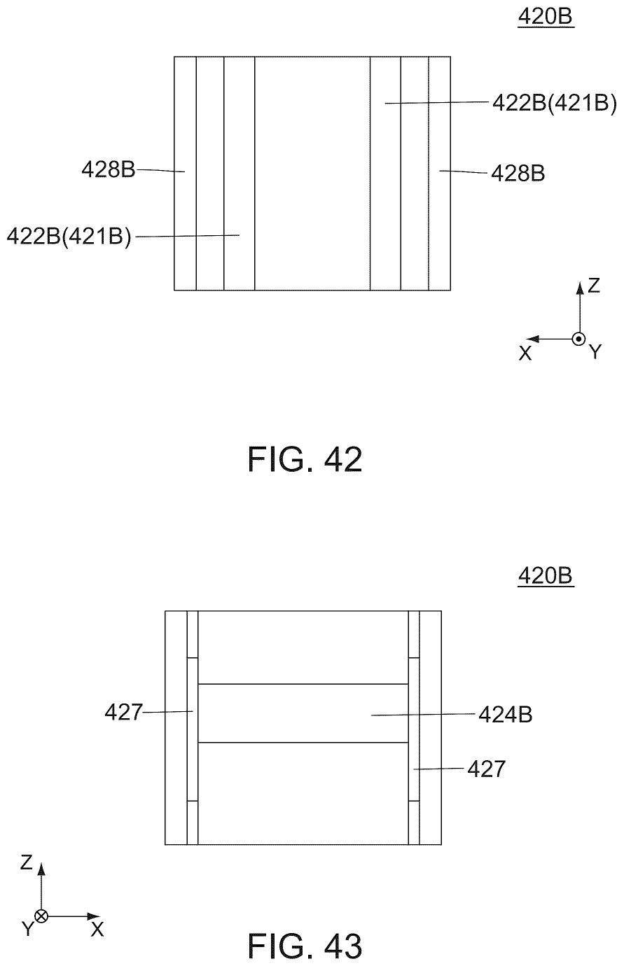

Referring to FIG. 42, the first member 420B of the present embodiment is made of insulator. However, the present invention is not limited thereto. The material of the first member 420B may be, for example, a conductive metal, and should be a material with sufficient strength. Referring to FIG. 40, the first member 420B is movable in the second direction. As shown in FIG. 30, the first member 420B has pressing portions 422B and a converting surface 424B.

As shown in FIG. 41, each of the pressing portions 422B of the present embodiment is a plane perpendicular to the second direction. Each of the pressing portions 422B faces outward in the second direction. As shown in FIG. 30, each of the pressing portions 422B is positioned outward of the converting surface 424B in the second direction. Each of the pressing portions 422B defines an outer end of the first member 420B in the second direction. None of the pressing portions 422B are fixed to the first busbar 200B. In other words, the first member 420B is not fixed to the first busbar 200B.

As shown in FIG. 30, the converting surface 424B of the present embodiment intersects with both the first direction and the second direction. More specifically, the converting surface 424B is a plane oblique to both the first direction and the second direction. However, the present invention is not limited thereto. The converting surface 424B may be a curved surface intersecting with both the first direction and the second direction. The converting surface 424B extends upward in the up-down direction and outward in the second direction. The converting surface 424B is positioned inward of any of the pressing portions 422B in the second direction.

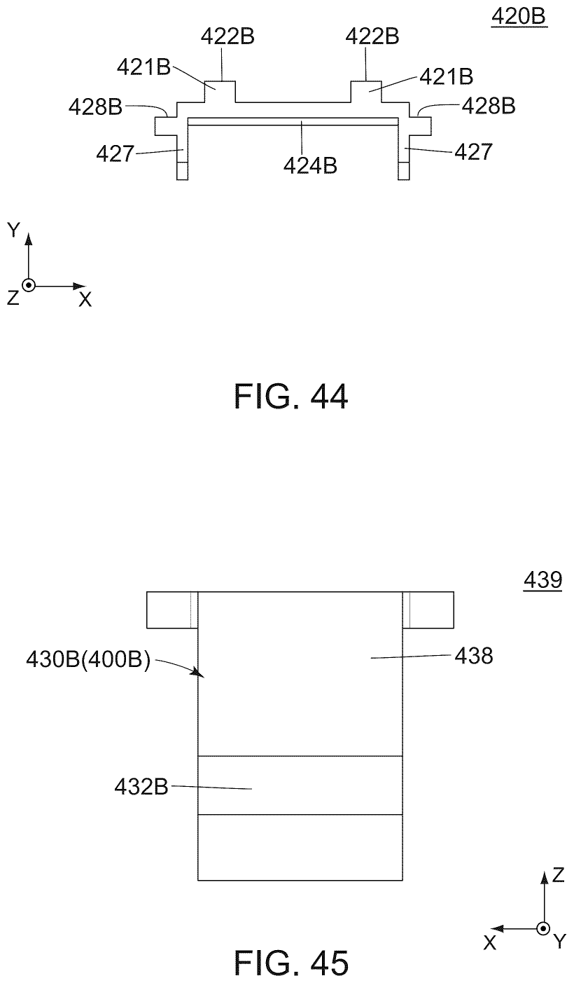

As shown in FIG. 44, the first member 420B has two protruding portions 421B. The pressing portion 422B is an outer end surface of the protruding portion 421B in the second direction.

As shown in FIG. 42, the first member 420B has two first-member-side spring receivers 428B.

As shown in FIG. 44, each of the first-member-side spring receivers 428B of the present embodiment is a plane perpendicular to the second direction. Each of the first-member-side spring receivers 428B faces outward in the second direction. Each of the first-member-side spring receivers 428B is positioned between each of the pressing portions 422B and the converting surface 424B in the second direction. Each of the first-member-side spring receivers 428B is positioned outward of the converting surface 424B in the second direction. Each of the first-member-side spring receivers 428B is positioned inward of any of the pressing portions 422B in the second direction.

As shown in FIG. 44, the first member 420B has two guide walls 427.

As shown in FIG. 44, each of the guide walls 427 of the present embodiment protrudes inward in the second direction. Each of the guide walls 427 defines an inner end of the first member 420B in the second direction. As shown in FIG. 43, the converting surface 424B is positioned between the two guide walls 427 in the third direction. The two guide walls 427 are positioned at opposite sides, respectively, of the converting surface 424B in the third direction.

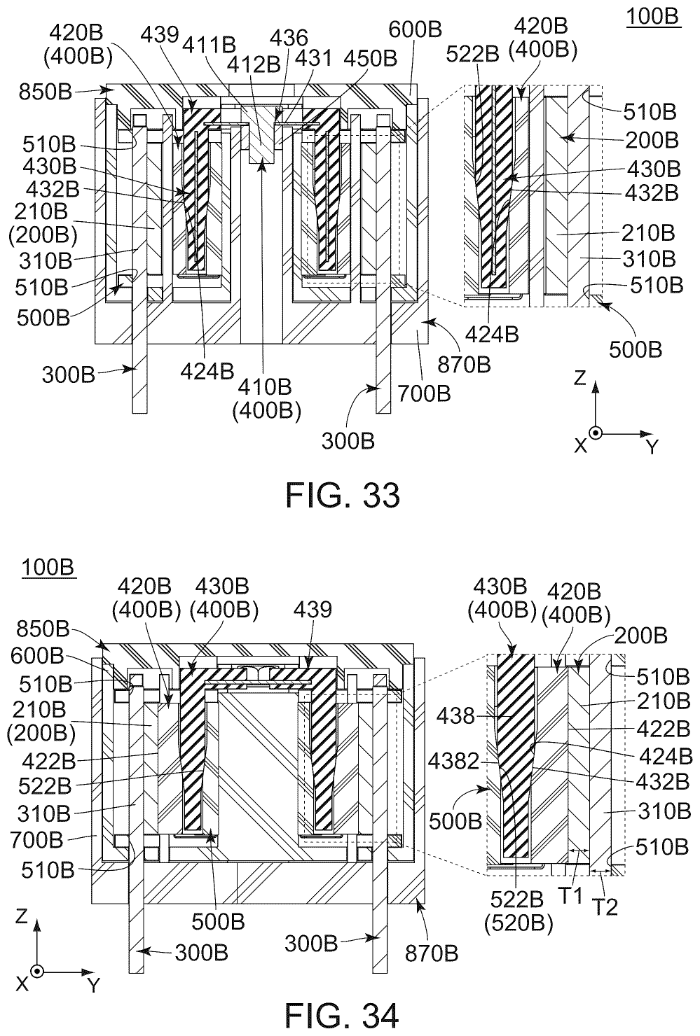

Referring to FIG. 33, the second member 430B of the present embodiment consists of a composite of metal and resin. As shown in FIG. 45, the second member 430B has a force application portion 432B.

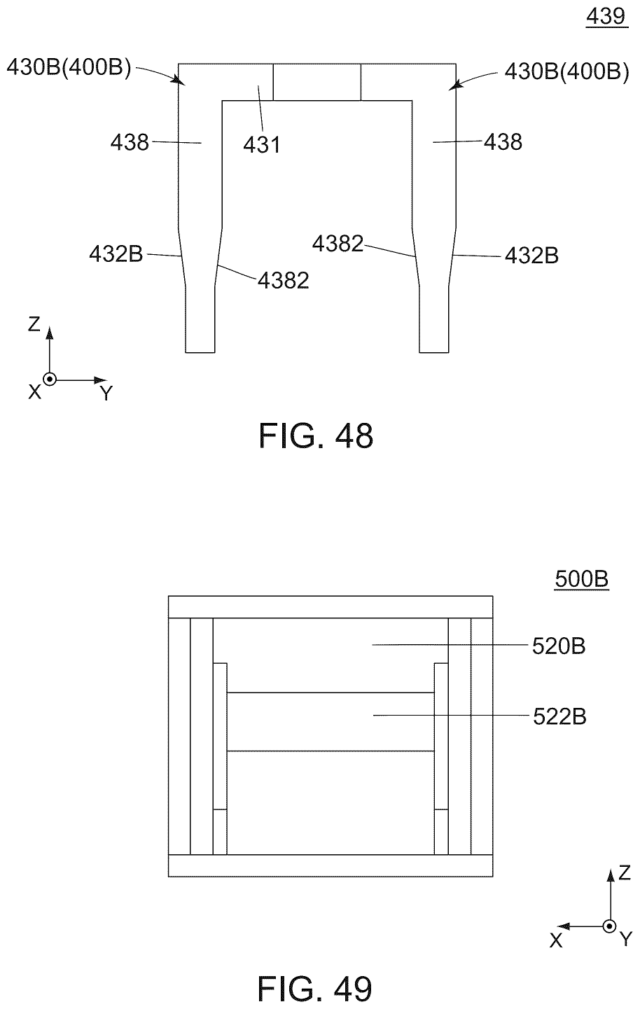

As shown in FIG. 48, the force application portion 432B of the present embodiment is positioned around a middle of the second member 430B in the first direction. The force application portion 432B intersects with both the first direction and the second direction. More in detail, the force application portion 432B is a plane oblique to both the first direction and the second direction. The force application portion 432B extends upward in the up-down direction and outward in the second direction. Referring to FIG. 30, the force application portion 432B and the first direction make an angle equal to an angle which the converting surface 424B and the first direction make. The force application portion 432B and the second direction make an angle equal to an angle which the converting surface 424B and the second direction make. The force application portion 432B is positioned at the same position as the converting surface 424B in the first direction under a state where the bolt 410B is not fastened. Referring to FIG. 34, when the bolt 410B is fastened, the second member 430B is moved along the first direction while the force application portion 432B presses the converting surface 424B. A lower end of the force application portion 432B is positioned below a lower end of the converting surface 424B under a state where the bolt 410B is fastened.

As shown in FIG. 41, the second member 430B further has a piercing hole 436 and an extending portion 438.

As shown in FIG. 41, the piercing hole 436 of the present embodiment is positioned around an upper end of the second member 430B. As shown in FIG. 33, the bolt 410B is inserted into the piercing hole 436. More in detail, the shaft portion 412B of the bolt 410B is inserted into the piercing hole 436.

As shown in FIG. 48, the extending portion 438 of the present embodiment extends along the first direction. Specifically, the extending portion 438 extends downward along the up-down direction. The force application portion 432B is provided on the extending portion 438. As shown in FIG. 34, the extending portion 438 and the first member 420B are positioned between the receiving portion 510B and a main portion 520B. Referring to FIGS. 40 and 41, the extending portion 438 of the second member 430B is positioned between the two guide walls 427 of the first member 420B under the state where the bolt 410B is fastened.

As shown in FIG. 47, the extending portion 438 is formed with an additional force application portion 4382.

As shown in FIG. 48, the additional force application portion 4382 is positioned around the middle of the second member 430B in the first direction. The additional force application portion 4382 intersects with both the first direction and the second direction. More in detail, the additional force application portion 4382 is a plane oblique to both the first direction and the second direction. The additional force application portion 4382 extends upward in the up-down direction and inward in the second direction.

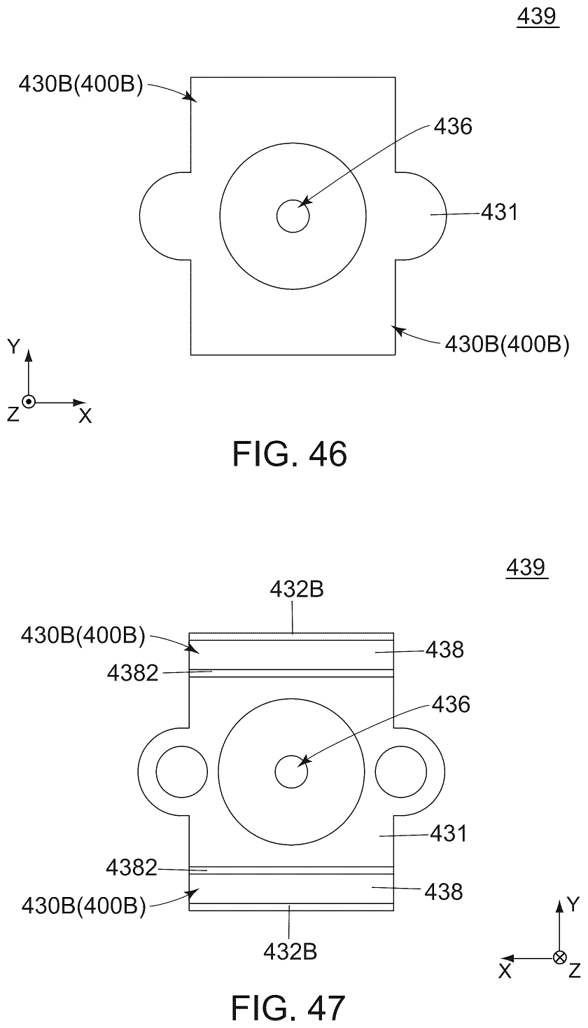

As shown in FIG. 46, the second member 430B has a ceiling portion 431.

As shown in FIG. 41, the ceiling portion 431 of the present embodiment defines the upper end of the second member 430B in the up-down direction. The piercing hole 436 pierces the ceiling portion 431 in the first direction.

As shown in FIG. 41, two of the second members 430B are coupled to each other by the common ceiling portion 431 to form a second member coupling body 439.

Referring to FIG. 51, the regulating member 500B of the present embodiment is made of insulator. The regulating member 500B has a receiving portion 510B. The receiving portion 510B of the present embodiment has a configuration same as that of the receiving portion 510A of the aforementioned second embodiment. Accordingly, a detail explanation thereabout will be omitted. Referring to FIG. 40, the regulating member 500B is movable in the second direction.

As shown in FIG. 51, the regulating member 500B further has the main portion 520B and arm portions 530B.

Referring to FIG. 51, the main portion 520B of the present embodiment defines an inner end of the regulating member 500B in the second direction. As shown in FIG. 49, the main portion 520B is formed with a facing taper portion 522B.

As shown in FIG. 30, the facing taper portion 522B of the present embodiment intersects with both the first direction and the second direction. More specifically, the facing taper portion 522B is a plane oblique to both the first direction and the second direction. However, the present invention is not limited thereto. The facing taper portion 522B may be a curved surface intersecting with both the first direction and the second direction. The facing taper portion 522B extends upward in the up-down direction and inward in the second direction. The facing taper portion 522B is positioned inward of the converting surface 424B in the second direction. The additional force application portion 4382 and the first direction make an angle equal to an angle which the facing taper portion 522B and the first direction make. The additional force application portion 4382 and the second direction make an angle equal to an angle which the facing taper portion 522B and the second direction make. The additional force application portion 4382 is positioned at the same position as the facing taper portion 522B in the first direction under the state where the bolt 410B is not fastened. Referring to FIG. 34, when the bolt 410B is fastened, the additional force application portion 4382 presses the facing taper portion 522B while the receiving portion 510B is moved toward the pressing portions 422B. A lower end of the additional force application portion 4382 is positioned below a lower end of the facing taper portion 522B under the state where the bolt 410B is fastened.

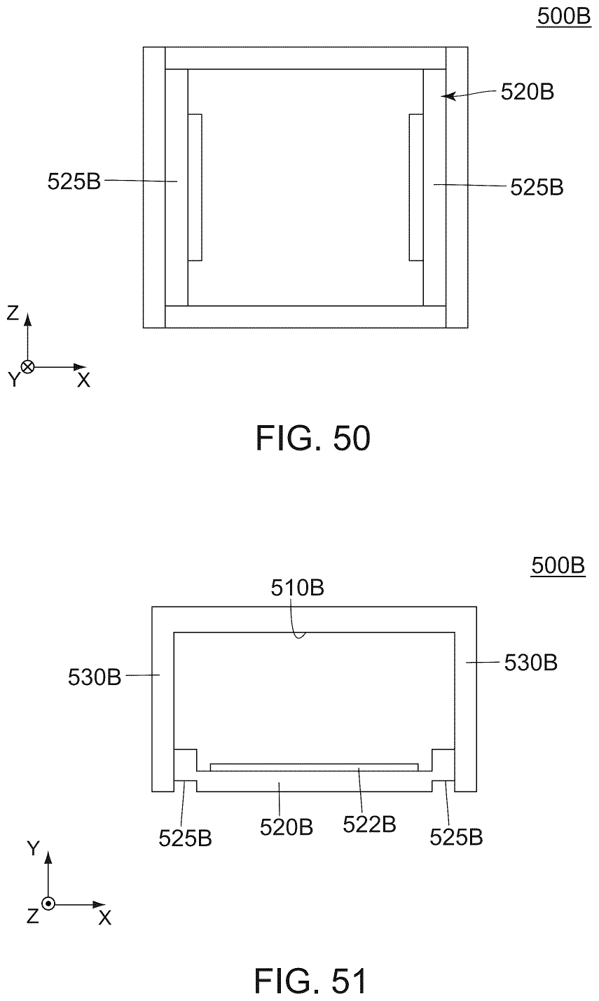

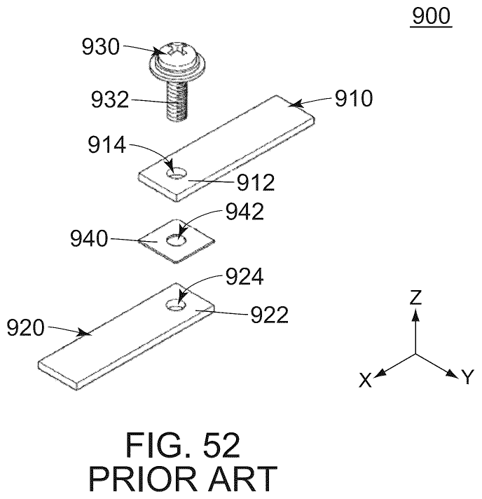

As shown in FIG. 50, the main portion 520B has two regulating-member-side spring receivers 525B.

As shown in FIG. 51, each of the regulating-member-side spring receivers 525B of the present embodiment is a plane perpendicular to the second direction. Each of the regulating-member-side spring receivers 525B faces inward in the second direction. Each of the regulating-member-side spring receivers 525B is positioned around an inner end of the regulating member 500B in the second direction.

As shown in FIG. 51, each of the arm portions 530B of the present embodiment extends from the main portion 520B. Specifically, each of the arm portions 530B extends outward in the second direction from the main portion 520B. Each of the arm portions 530B supports the receiving portion 510B.

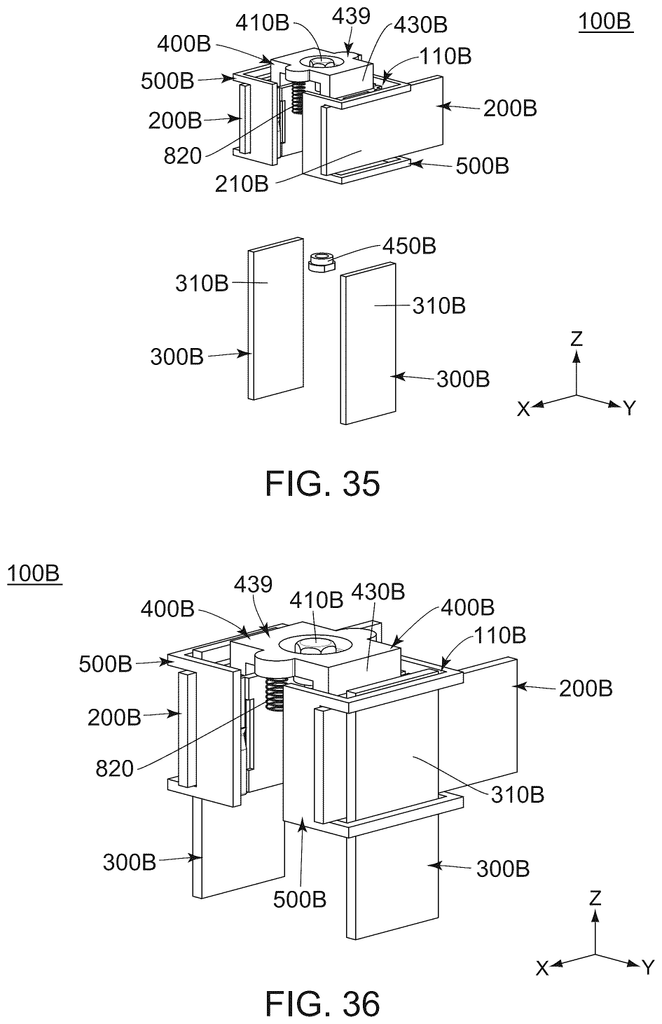

As shown in FIG. 35, the busbar connection body 100B is formed with accommodation spaces 110B each of which accommodates both the first contact portion 210B and the second contact portion 310B.

As shown in FIG. 30, the accommodation space 110B of the present embodiment is positioned between each of the pressing portions 422B and the receiving portion 510B. As shown in FIG. 36, the accommodation space 110B is opened in the first direction. The accommodation space 110B is opened in the third direction. The accommodation space 110B extends in the first direction. The accommodation space 110B extends in the third direction. The second contact portion 310B is accommodated in the accommodation space 110B along the first direction. However, the present invention is not limited thereto. Specifically, the busbar connection body 100B should be configured so that at least one of the first contact portion 210B and the second contact portion 310B is accommodated in the accommodation space 110B along the first direction.

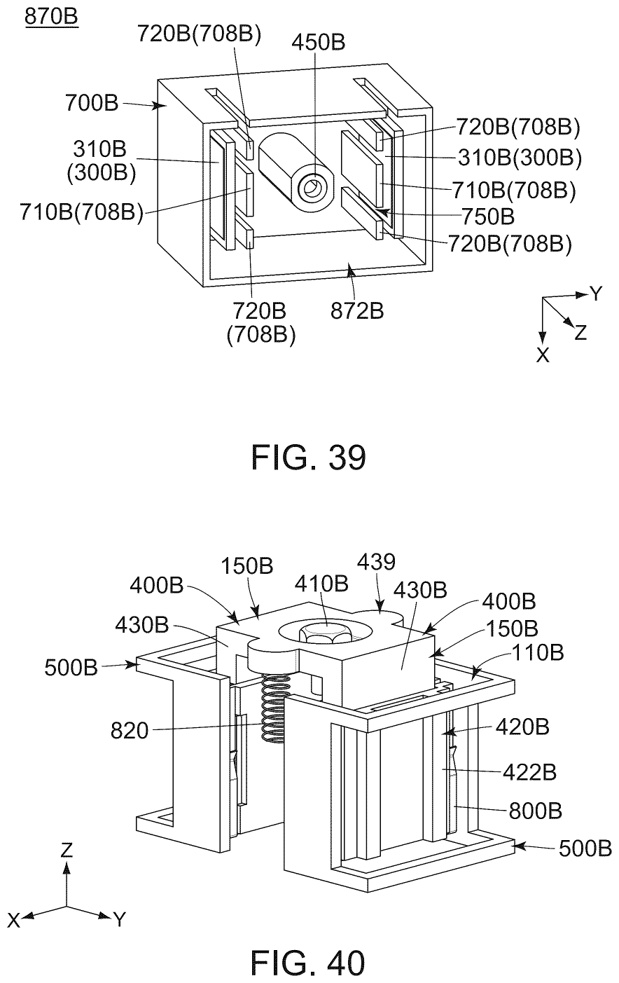

As shown in FIG. 39, the busbar connection body 100B further comprises a nut 450B.

As shown in FIG. 33, the nut 450B of the present embodiment is positioned below the ceiling portion 431 of the second member 430B in the up-down direction. Specifically, the nut 450B is positioned just below the ceiling portion 431 in the up-down direction. The nut 450B is positioned above the converting surface 424B of the first member 420B in the up-down direction. The nut 450B is positioned above the facing taper portion 522B of the regulating member 500B in the up-down direction.

Referring to FIG. 33, the ceiling portion 431 of the second member 430B is sandwiched between the head portion 411B of the bolt 410B and the nut 450B when the bolt 410B is screwed into the nut 450B.

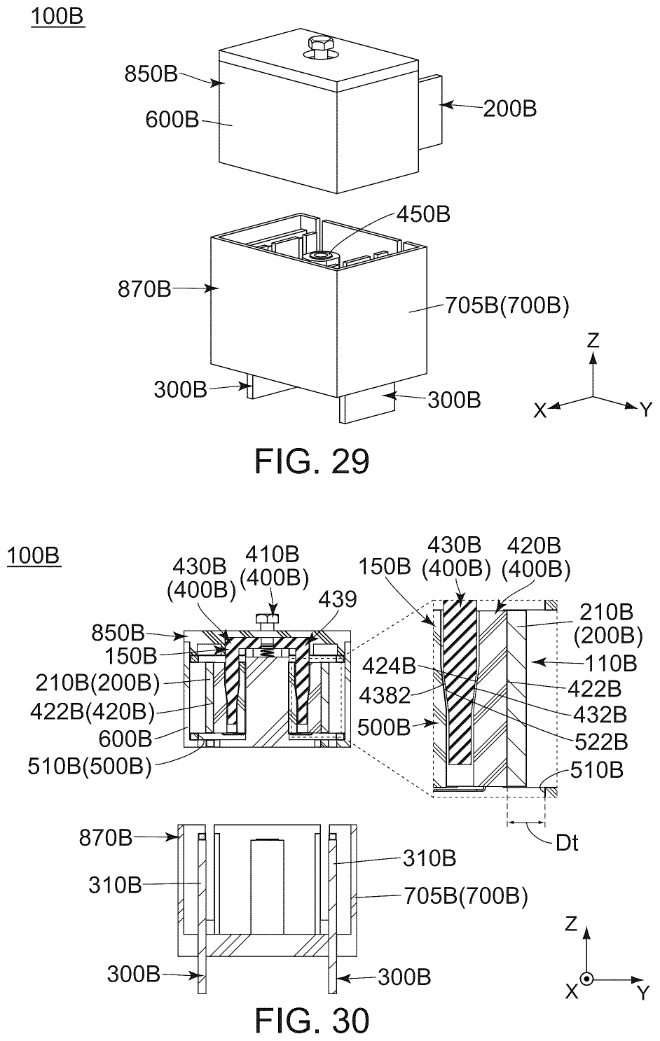

As shown in FIG. 29, the busbar connection body 100B further comprises a first housing 600B and a second housing 700B. However, the present invention is not limited thereto. The busbar connection body 100B may comprise no first housing 600B. Additionally, the busbar connection body 100B may comprise no second housing 700B.

Referring to FIG. 30, the first housing 600B of the present embodiment is made of insulator. The first housing 600B holds all of the first busbars 200B, the press mechanisms 400B and the regulating members 500B.

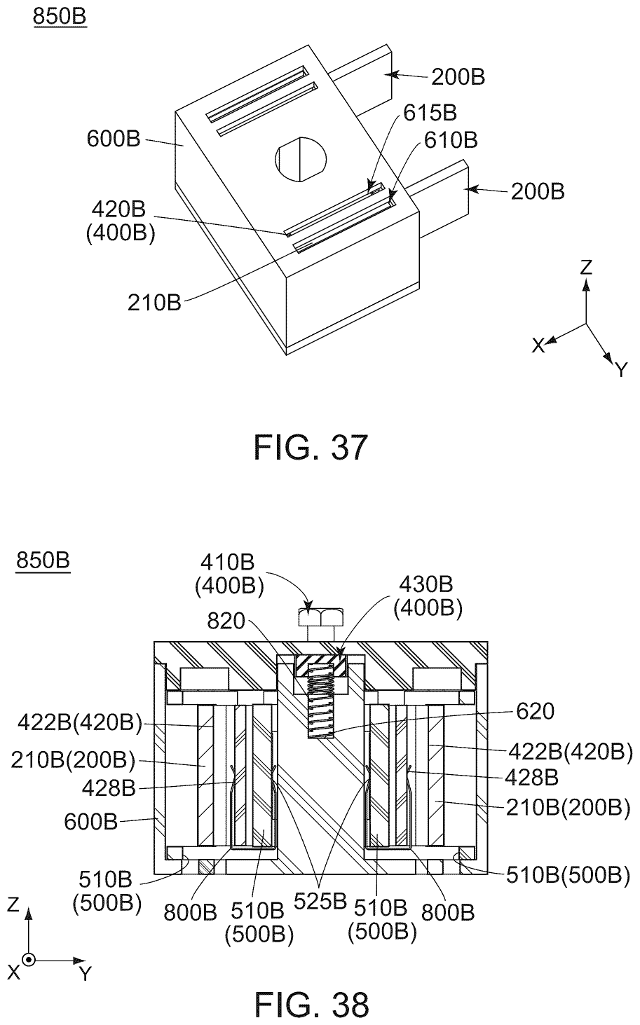

As shown in FIG. 37, the first housing 600B has two insertion holes 610B. The insertion hole 610B has a configuration same as that of the insertion hole 610 of the aforementioned second embodiment. Accordingly, a detail explanation thereabout will be omitted.

As shown in FIG. 38, the first housing 600B has a push-up member receive portion 620.

Referring to FIG. 39, the second housing 700B of the present embodiment is made of insulator. The second housing 700B of the present embodiment holds the second busbars 300B.

As shown in FIG. 33, the first contact portion 210B is pressed against the second contact portion 310B when the first housing 600B is mated with the second housing 700B and the bolt 410B is fastened. Specifically, the first contact portion 210B is pressed against the second contact portion 310B when the first housing 600B is mated with the second housing 700B and the bolt 410B is screwed into the nut 450B.

As shown in FIG. 29, the second housing 700B has an outer wall 705B. The outer wall 705B of the present embodiment has a configuration same as that of the outer wall 705 of the aforementioned second embodiment. Accordingly, a detail explanation thereabout will be omitted.

As shown in FIG. 39, the second housing 700B has two partition portions 708B. Each of the partition portions 708B consists of a first partition portion 710B and two second partition portions 720B. The first partition portions 710B and the second partition portion 720B are arranged with a space 750B left therebetween. The partition portion 708B of the present embodiment has a configuration same as that of the partition portion 708 of the aforementioned second embodiment. Accordingly, a detail explanation thereabout will be omitted.

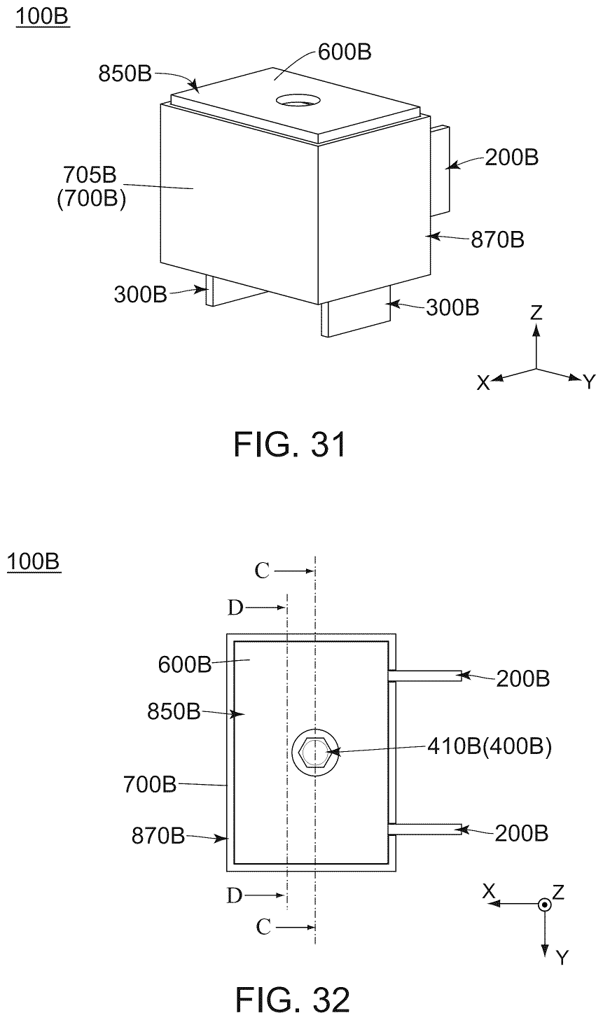

As shown in FIG. 29, the busbar connection body 100B comprises a first structure 850B and a second structure 870B. Referring to FIGS. 29 and 31, the first structure 850B and the second structure 870B are mateable with each other along the first direction.

As shown in FIG. 30, the first structure 850B of the present embodiment comprises the first housing 600B, the two first busbars 200B, the two press mechanisms 400B and the two regulating members 500B. In the present application, the first structure 850B is referred to as a structure 850B. However, the present invention is not limited thereto. Specifically, the structure 850B should comprise the first housing 600B, the single first busbar 200B, the single press mechanism 400B and the single regulating member 500B.

As shown in FIG. 39, the second structure 870B of the present embodiment comprises the second housing 700B, the two second busbars 300B and the single nut 450B. However, the present invention is not limited thereto. Specifically, the number of the second busbar 300B, which the second structure 870B comprises, may be one.

As shown in FIG. 39, the second structure 870B has a receiver portion 872B. The receiver portion 872B is a space recessed downward in the up-down direction.

As shown in FIG. 41, the busbar connection body 100B further comprises spring members 800B. Each of the spring members 800B has a base portion 802B and four resilient pieces 804B, 806B. The spring member 800B of the present embodiment has a configuration similar to that of the spring member 800 of the aforementioned second embodiment. Accordingly, a detail explanation thereabout will be omitted.

Referring to FIG. 41, the press mechanism 400B, the regulating member 500B and the spring member 800B form a connection component 150B. As shown in FIG. 30, the busbar connection body 100B comprises two of the connection components 150B that share both the bolt 410B and a part of the second member 430B.

As shown in FIG. 40, the busbar connection body 100B further comprises a push-up member 820.

Referring to FIG. 40, the push-up member 820 of the present embodiment is made of metal. Specifically, the push-up member 820 is a spring. Referring to FIGS. 38 and 40, the push-up member 820 is positioned between the ceiling portion 431 of the second member 430B and the push-up member receive portion 620 of the first housing 600B in the first direction. The push-up member 820 is sandwiched between the ceiling portion 431 and the push-up member receive portion 620. The push-up member 820 is positioned below the ceiling portion 431 of the second member 430B in the up-down direction. The push-up member 820 is positioned above the push-up member receive portion 620 of the first housing 600B in the up-down direction. The push-up member 820 enables the second member coupling body 439 to be positioned upward of any of the first members 420B and the regulating members 500B in the up-down direction under the state where the bolt 410B is not fastened.

Hereinafter, an explanation will be made about an operation of connecting the first busbars 200B with the second busbars 300B.

First, the first structure 850B and the second structure 870B are arranged in the first direction so that the first structure 850 and the second structure 870 take a state shown in FIG. 29. Next, the first structure 850B and the second structure 870B approach each other in the first direction. Then, the first structure 850B and the second structure 870B change their state into a state as follows: a part of the first structure 850B is received in the receiver portion 872B of the second structure 870B; the second contact portions 310B of the second structure 870B are accommodated in the accommodation spaces 110B via the insertion holes 610B, respectively, of the first structure 850B; the partition portions 708B of the second structure 870B are accommodated in the first housing 600B via the additional insertion holes 615B, respectively, of the first structure 850B; and the bolt 410B is inserted into a hole of the nut 450B. This state is referred to as a pre-fastening state. In the pre-fastening state, the second contact portion 310B is positioned between the first contact portion 210B and the receiving portion 510B in the accommodation space 110B.

From the pre-fastening state, the bolt 410B is screwed into the nut 450B. Then, the force application portion 432B presses the converting surface 424B in the first direction. The pressing of the force application portion 432B causes that each of the pressing portions 422B presses the first contact portion 210B against the second contact portion 310B in the second direction while the receiving portion 510B receives the second contact portion 310B. Accordingly, the first busbar 200B and the second busbar 300B are connected to each other, and the connecting operation is completed.

More specifically, when the bolt 410B is screwed into the nut 450B in the pre-fastening state, the bolt 410B is moved downward and the bolt 410B moves the second member coupling body 439 downward against the push-up member 820. This causes that the force application portion 432B of the second member 430B presses the converting surface 424B of the first member 420B downward while the additional force application portion 4382 of the second member 430B presses the facing taper portion 522B of the regulating member 500B downward.

As described above, the converting surface 424B of the first member 420B extends upward in the up-down direction and outward in the second direction. Accordingly, the pressing of the force application portion 432B is converted by the converting surface 424B to a force which presses the first member 420B outward in the second direction. This causes that the first member 420B is moved outward in the second direction while each of the pressing portions 422B presses the first contact portion 210B outward in the second direction.

As described above, the facing taper portion 522B of the regulating member 500B extends upward in the up-down direction and inward in the second direction. Accordingly, the pressing of the additional force application portion 4382 is converted by the facing taper portion 522B to a force which presses the regulating member 500B inward in the second direction. This causes that the regulating member 500B is moved inward in the second direction while the receiving portion 510B presses the second contact portion 310B inward in the second direction.

Thus, the first contact portion 210B and the second contact portion 310B are pressed in orientations in which the first contact portion 210B and the second contact portion 310B approach each other in the second direction, and the first busbar 200B and the second busbar 300B are connected to each other.

Summarizing the above, the force application portion 432B presses the converting surface 424B at least in the first direction when the bolt 410B is fastened under a state where the second contact portion 310B is positioned between the first contact portion 210B and the receiving portion 510B in the accommodation space 110B. Additionally, when the force application portion 432B presses the converting surface 424B, each of the pressing portions 422B presses the first contact portion 210B against the second contact portion 310B in the second direction while the receiving portion 510B receives the second contact portion 310B.

The busbar connection body 100B of the present embodiment is configured so that the first direction, in which the shaft portion 412B of the bolt 410B for fastening the first busbar 200B and the second busbar 300B to each other extends, is perpendicular to the second direction in which the first contact portion 210B is pressed against the second contact portion 310B. In other words, the busbar connection body 100B of the present embodiment is configured so that the direction, in which the shaft portion 412B of the bolt 410B extends, coincides with the direction in which the second contact portion 310B extends. Thus, the busbar connection body 100B of the present embodiment is configured so that space for operation of fastening the first busbar 200B and the second busbar 300B to each other by the bolt 410B is provided along the direction in which the second contact portion 310B extends. Consequently, the busbar connection body 100B of the present embodiment does not unnecessarily restrict placement of components around the busbar connection body 100B.

Referring to FIGS. 30 and 34, a distance Dt between each of the pressing portions 422B and the receiving portion 510B in the second direction before the bolt 410B is fastened is greater than a sum of a thickness T1 of the first contact portion 210B and a thickness T2 of the second contact portion 310B. This reduces an insertion force of the second busbar 300B of the second structure 870B when the second busbar 300B of the second structure 870B is inserted into the accommodation space 110B of the first structure 850B.

As described above, the busbar connection body 100B of the present embodiment is configured as follows: the extending portion 438 is formed with the additional force application portion 4382; the main portion 520B of the regulating member 500B is formed with the facing taper portion 522B; and the regulating member 500B is movable in the second direction. However, the present invention is not limited thereto. Specifically, the busbar connection body 100B may be configured as follows: the extending portion 438 is formed with no additional force application portion 4382; the main portion 520B is formed with no facing taper portion 522B; and the regulating member 500B is immovable in the second direction.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A busbar connection body comprising a first busbar, a second busbar, a press mechanism and a regulating member, wherein:
the first busbar has a first contact portion;
the second busbar has a second contact portion;
the press mechanism comprises a bolt, a first member and a second member;
the bolt has a shaft portion extending in a first direction;
the first member has a pressing portion and a converting surface;
the converting surface intersects with both the first direction and a second direction perpendicular to the first direction;
the second member has a force application portion;
the regulating member has a receiving portion;
the receiving portion is positioned apart from the pressing portion in the second direction;
the busbar connection body has a predetermined distance between the pressing portion and the receiving portion in the second direction before the bolt is fastened;
the predetermined distance is greater than a sum of a thickness of the first contact portion and a thickness of the second contact portion;
the busbar connection body is formed with an accommodation space which accommodates both the first contact portion and the second contact portion;
the accommodation space is positioned between the pressing portion and the receiving portion;
the force application portion presses the converting surface at least in the first direction when the bolt is fastened under a state where the second contact portion is positioned between the first contact portion and the receiving portion in the accommodation space; and
when the force application portion presses the converting surface, the pressing portion presses the first contact portion against the second contact portion in the second direction while the receiving portion receives the second contact portion.

2. The busbar connection body as recited in claim 1, wherein:
the accommodation space is opened in the first direction; and
at least one of the first contact portion and the second contact portion is accommodated in the accommodation space along the first direction.

3. The busbar connection body as recited in claim 1, wherein:
the first member is formed with a first piercing hole;
the second member is formed with a second piercing hole;
the shaft portion of the bolt is inserted into both the first piercing hole and the second piercing hole;
the regulating member is a band; and
the band holds the first member and the second member together under a state where the bolt is fastened.

4. The busbar connection body as recited in claim 1, wherein:
the bolt also serves as the second member;
the bolt is formed with a conical base portion;
the conical base portion functions as the force application portion;
the regulating member further has a main portion and an arm portion;
the main portion is formed with a facing taper portion;
the arm portion extends from the main portion and supports the receiving portion;
when the bolt is fastened, the conical base portion presses the converting surface so that the pressing portion is moved toward the receiving portion; and
when the bolt is fastened, the conical base portion presses the facing taper portion so that the receiving portion is moved toward the pressing portion;

5. The busbar connection body as recited in claim 4, wherein:
the busbar connection body further comprises a first housing and a second housing;
the first housing holds the first busbar, the press mechanism and the regulating member;
each of the regulating member and the first member is movable in the second direction;
the second housing holds the second busbar; and
the first contact portion is pressed against the second contact portion when the first housing is mated with the second housing and the bolt is fastened.

6. The busbar connection body as recited in claim 1, wherein:
the second member further has a piercing hole and an extending portion;
the bolt is inserted into the piercing hole;
the extending portion extends along the first direction;
the force application portion is provided on the extending portion;
the regulating member further has a main portion and an arm portion;
the arm portion extends from the main portion and supports the receiving portion;
each of the extending portion and the first member is positioned between the receiving portion and the main portion; and
when the bolt is fastened, the second member is moved along the first direction while the force application portion presses the converting surface.

7. The busbar connection body as recited in claim 6, wherein:
the extending portion is formed with an additional force application portion;
the main portion is formed with a facing taper portion; and
when the bolt is fastened, the additional force application portion presses the facing taper portion so that the receiving portion is moved toward the pressing portion.

8. The busbar connection body as recited in claim 7, wherein:
the busbar connection body further comprises a first housing and a second housing;
the first housing holds the first busbar, the press mechanism and the regulating member;
each of the regulating member and the first member is movable in the second direction;
the second housing holds the second busbar; and
the first contact portion is pressed against the second contact portion when the first housing is mated with the second housing and the bolt is fastened.

9. The busbar connection body as recited in claim 4, wherein:
the busbar connection body further comprises a spring member; and
the spring member sandwiches both the main portion and the first member so that the main portion is urged toward the converting surface.

10. The busbar connection body as recited in claim 6, wherein:
the busbar connection body further comprises a spring member; and
the spring member sandwiches both the main portion and the first member so that the main portion is urged toward the converting surface.

11. A structure comprising the first housing as recited in claim 5, the first busbar, the press mechanism and the regulating member.

12. A structure comprising the first housing as recited in claim 8, the first busbar, the press mechanism and the regulating member.
